(19) United States
(12) Patent Application Publication
(10) Pub. No.: US 2018/0223100 A1
(43) Pub. Date: Aug. 9, 2018

(54) HOLOGRAPHIC MEDIA CONTAINING CHAIN-SUBSTITUTED CYANINE DYES

(71) Applicant: Covestro Deutschland AG, Leverkusen (DE)

(72) Inventors: HORST BERNETH, Leverkusen (DE); Thomas FÄCKE, Leverkusen (DE); Thomas RÕLLE, Leverkusen (DE); Serguei KOSTROMINE, Swisttal-Buschhoven (DE); Friedrich-Karl BRUDER, Krefeld (DE); Dennis HÕNEL, Zulpich-Wichterich (DE)

(21) Appl. No.: 15/737,853

(22) PCT Filed: Jun. 21, 2016
(86) PCT No.: PCT/EP2016/064302

§ 371 Date: Dec. 19, 2017

(30) Foreign Application Priority Data
Jun. 23, 2015 (EP) 15173234.4

(51) Int. Cl. C08L 75/04; C08K 5/3492; C09B 23/04; C09B 23/06; C09B 23/10; G03H 1/02; G03H 1/04; G03H 1/26; G11B 7/245

(52) U.S. Cl. CPC C08L 75/04; C08L 2205/22; C09B 23/04; C09B 23/06; C09B 23/105; G03H 1/02; G03H 1/0404; G03H 1/0408; G03H 1/268; G11B 7/245; G03H 2001/0413; G03H 2001/0415; G03H 2222/33; G03H 2260/12; C08K 5/3492

(57) ABSTRACT

The present invention relates to a photopolymer composition comprising a photopolymerizable component and a photoinitiator system comprising a chain-substituted cyanine dye. The invention further provides a photopolymer comprising a photopolymer composition according to the invention, a holographic medium comprising a photopolymer according to the invention, the use of a holographic medium according to the invention, and a process for producing a holographic medium by using the photopolymer according to the invention and the exposure of the corresponding holographic medium with the aid of pulsed laser radiation.

The present invention relates to a photopolymer composition comprising a photopolymerizable component and a photoinitiator system comprising a chain-substituted cyanine dye. The invention further provides a photopolymer comprising a photopolymer composition according to the invention, a holographic medium comprising a photopolymer according to the invention, the use of a holographic medium according to the invention, and a process for producing a holographic medium by using the photopolymer according to the invention and the exposure of the corresponding holographic medium with the aid of pulsed laser radiation.

Photopolymer compositions of the type mentioned at the beginning are known in the prior art. WO 2008/125229 A1 for instance describes a photopolymer composition and a photopolymer obtainable therefrom which each comprise polyurethane matrix polymers, an acrylate-based writing monomer and also photoinitiators comprising a coinitiator and a dye. The uses of photopolymers are decisively determined by the refractive index modulation Δn produced by holographic exposure. In holographic exposure, the interference field of signal light beam and reference light beam (that of two plane waves in the simplest case) is mapped into a refractive index rating by the local photopolymerization of writing monomers such as, for example, high-refractive acrylates at loci of high intensity in the interference field. The refractive index rating in the photopolymer (the hologram) contains all the information of the signal light beam. By illuminating the hologram with only the reference light beam, the signal can then be reconstructed. The strength of the signal thus reconstructed relative to the strength of the incident reference light is called the diffraction efficiency, DE in what follows.

In the simplest case of a hologram resulting from the superposition of two plane waves, the DE is the ratio of the intensity of the light diffracted on reconstruction to the sum total of the intensities of diffracted light and nondiffracted light. The higher the DE, the greater the efficiency of a hologram with regard to the amount of reference light needed to visualize the signal with a defined brightness.

In order that a very high Δn and DE may be realized for holograms, the matrix polymers and the writing monomers of a photopolymer composition should in principle be chosen such that there is a very large difference in their refractive indices. One possible way to realize this is to use matrix polymers having a very low refractive index and writing monomers having a very high refractive index. Suitable matrix polymers of low refractive index are, for example, polyurethanes obtainable by reaction of a polyol component with a polyisocyanate component.

In addition to high DE and Δn values, however, another important requirement for holographic media from photopolymer compositions is that the matrix polymers be highly crosslinked in the final medium. When the degree of crosslinking is too low, the medium will lack adequate stability. One consequence of this is to appreciably reduce the quality of holograms inscribed in the media. In the worst case, the holograms may even be subsequently destroyed.

It is further very important, in particular for the large scale industrial production of holographic media from photopolymer compositions, that the photosensitivity be sufficient to achieve large-area exposure with any given source of laser light without loss of index modulation. Particularly the choice of a suitable photoinitiator here is of decisive importance for the properties of the photopolymer.

However, holographic exposure using a continuous source of laser light comes up against technical limits in the case of large-area exposure, since efficient formation of the hologram will always require a certain dose of light per unit area and the technically available laser power is limited. Large-area exposures at a comparatively low dose of radiation additionally require long exposure times which in turn impose very high requirements on the mechanical damping of the exposure set-up to eliminate vibration.

A further possible way to achieve large-area exposure of holograms consists in using very short pulses of light, for example from pulsed lasers or continuous wave lasers in conjunction with very fast shutters. Pulse durations with pulsed lasers are typically 500 ns or less. Pulse durations with continuous wave lasers and very fast shutters are typically 100 μs or less. In effect, the same amount of energy can be introduced here as with continuous lasers in seconds. Holograms can be written in this way dot by dot.

Since pulsed lasers or fast optical shutters are technically available and an exposure set-up of this type has very low requirements with regard to mechanical damping to eliminate vibration, this amounts to a good technical alternative to the above-described set-ups involving continuous lasers for large-area exposure of holograms.

The photopolymers known from WO 2008/125229 A1 are by reason of the photoinitiators used therein insufficiently photosensitive to be useful in the writing of holograms with pulsed lasers.

The problem addressed by the present invention was therefore that of providing a photopolymer composition useful in the production of photopolymers whereinto holograms can be written with pulsed lasers by reason of higher photosensitivity.

This problem is solved by a photopolymer composition comprising a photopolymerizable component and a photoinitiator system comprising a chain-substituted cyanine dye of the formula (I)

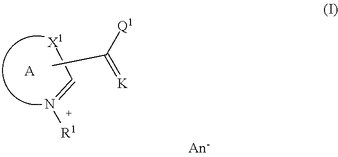

in which
K is a radical of the formula (II)

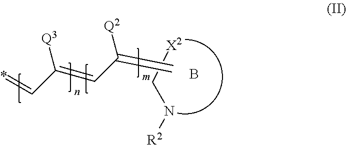

(III)

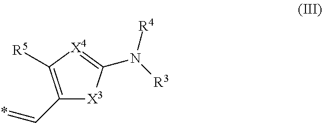

or (IV)

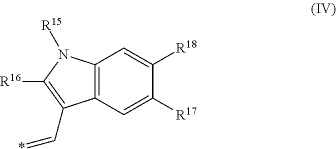

ring A together with N and X¹ and the atoms that connect them and ring b together with N and X² and the atoms that connect them are independently a five- or six-membered aromatic or quasiaromatic or partly hydrogenated heterocyclic ring which may contain 1 to 4 heteroatoms and/or may be benzo- or naphthofused and/or may be substituted by C₁- to C₈-alkyl, C₃- to C₆-alkenyl, C₄- to C₇-cycloalkyl or C₇- to C₁₀-aralkyl, aryl, fluorine, chlorine, bromine, methoxy, ethoxy, where the unsaturated unit (*(C=K)-Q¹) in the formula (I) joins onto the ring A or B in position 2 or 4 relative to X¹ or X²,
X¹ is O, S, N—R⁷, CR⁹ or CR¹¹R¹²,
X² is O, S, N—R⁸, CR¹⁰ or CR¹³R¹⁴,
Q¹ is hydrogen, cyano or methyl,
Q² is hydrogen or cyano,
Q³ is hydrogen or a radical of the formula (V)

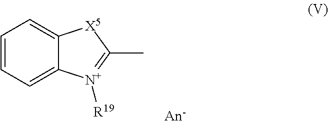

where at least one of the Q¹, Q² and Q³ radicals is not hydrogen,
X³ is O or S,
X⁴ is N or C—R⁶,
X⁵ is N, O or CR²⁰R²⁰,
R¹, R², R⁷, R⁸, R¹⁵ and R¹⁹ are independently C₁- to C₈-alkyl, C₃- to C₆-alkenyl, C₄- to C₇-cycloalkyl or C₇- to C₁₀-aralkyl and
R¹⁵ may additionally be hydrogen,
R⁹ and R¹⁰ are independently hydrogen or C₁- to C₂-alkyl,
R¹¹, R¹², R¹³, R¹⁴ and R²⁰ are independently C₁- to C₄-alkyl, C₃- to C₆-alkenyl, C₄- to C₇-cycloalkyl or C₇- to C₁₀-aralkyl or R¹¹ and R¹² together and/or R¹³ and R¹⁴ together form a —CH₂—CH₂—CH₂—CH₂— or —CH₂—CH₂—CH₂—CH₂—CH₂— bridge and, in addition,
R⁷, R⁹ or R¹² together with Q¹ can form a —CH₂—CH₂— or —CH₂—CH₂—CH₂— bridge,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³, R⁴ form a —CH₂—CH₂—CH₂—CH₂—, —CH₂—CH₂—CH₂CH—CH₂—CH₂—, —CH₂—CH₂—O—CH₂—CH₂—, —CH₂—CH₂—NH—CH₂—CH₂— or —CH₂—N(alkyl)-CH₂—CH₂— bridge,
R⁵ and R¹⁶ are independently hydrogen, C₁- to C₈-alkyl, C₄- to C₇-cycloalkyl or C₆- to C₁₀-aryl,
R⁶ is hydrogen, alkyl or cyano,
R¹⁷ and R¹⁸ are independently hydrogen, chlorine, methyl, ethyl, methoxy or ethoxy,
n and m are independently 0 or 1,
where m is only 1 when n is also 1, and
An⁻ represents the equivalent of one anion.

In a further embodiment of the invention,
Q¹ is cyano or, together with R², forms a —CH₂—CH₂—CH₂— bridge,
Q² is hydrogen or cyano, preferably hydrogen,
Q³ is hydrogen,
the ring A together with R¹, N and X¹ and the atoms that connect them are a radical of the formulae

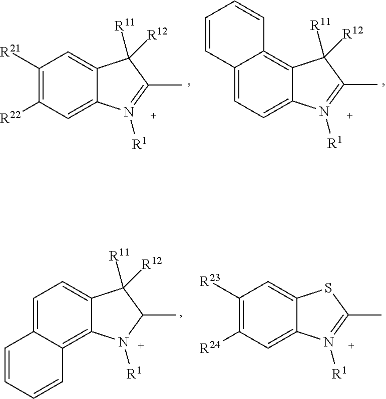

R¹ is C₁- to C₈-alkyl, C₃- to C₆-alkenyl, C₄- to C₇-cycloalkyl or C₇- to C₁₀-aralkyl, R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy, where preferably just one of the two is not hydrogen,
R²³ and R²⁴ are independently hydrogen, chlorine, cyano, methyl, ethyl, methoxy or ethoxy, where preferably just one of the two is not hydrogen,
the ring B together with R², N and X² and the atoms that connect them are a radical of the formulae

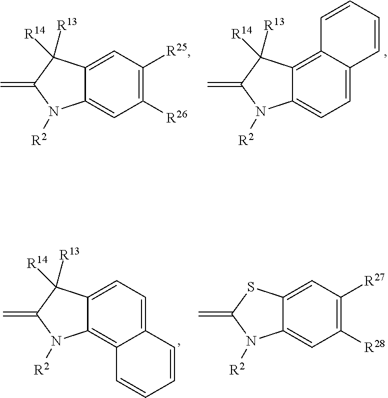

R² is C₁- to C₈-alkyl, C₃- to C₆-alkenyl, C₄- to C₇-cycloalkyl or C₇- to C₁₀-aralkyl,
R¹³ and R¹⁴ are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²⁵ and R²⁶ are independently hydrogen, chlorine, nitro, cyano, methoxycarbonyl, ethoxycarbonyl, methyl, ethyl, methoxy or ethoxy, where preferably just one of the two is not hydrogen,
R²⁷ and R²⁸ are independently hydrogen, chlorine, cyano, methyl, ethyl, methoxy or ethoxy, where preferably just one of the two is not hydrogen,
X³ is S,
X⁴ is N or C—R⁶, preferably N,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³, R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is C₁- to C₈-alkyl or C₈- to C₁₀-aryl,
R⁶ is hydrogen or cyano,
R¹⁵ is hydrogen, C₁- to C₈-alkyl, C₃- to C₆-alkenyl, C₄- to C₇-cycloalkyl or C₇- to C₁₀-aralkyl,
R¹⁶ is hydrogen, C₁- to C₄-alkyl, C₅- to C₆-cycloalkyl or C₆-aryl,
R¹⁷ and R¹⁸ are independently hydrogen, chlorine, methyl or methoxy, where preferably just one of the two is not hydrogen,
n and m are independently 0 or 1,
where m is only 1 when n is also 1, and
An⁻ represents the equivalent of one anion.

A further embodiment of the invention is characterized in that
Q¹ and Q² are hydrogen,
Q³ is a radical of the formula (V),
the ring A together with R¹, N and X¹ and the atoms that connect them are a radical of the formulae

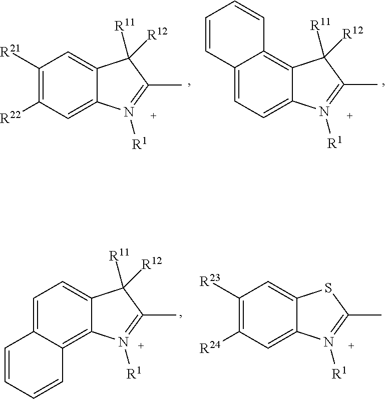

R¹ and R¹⁹ are independently C₁- to C₈-alkyl, C₃- to C₆-alkenyl, C₄- to C₇-cycloalkyl or C₇- to C₁₀-aralkyl,
R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy, where preferably just one of the two is not hydrogen,
R²³ and R²⁴ are independently hydrogen, chlorine, cyano, methyl, ethyl, methoxy or ethoxy, where preferably just one of the two is not hydrogen,
the ring B together with R², N and X² and the atoms that connect them are a radical of the formulae

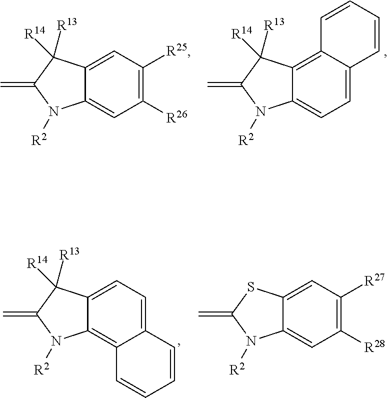

R² is C₁- to C-alkyl, C₃- to C-alkenyl, C₄- to C₇-cycloalkyl or C₇- to C₁₀-aralkyl,
R¹³ and R¹⁴ are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²⁵ and R²⁶ are independently hydrogen, chlorine, nitro, cyano, methoxycarbonyl, ethoxycarbonyl, methyl, ethyl, methoxy or ethoxy, where preferably just one of the two is not hydrogen,
R²⁷ and R²⁸ are independently hydrogen, chlorine, cyano, methyl, ethyl, methoxy or ethoxy, where preferably just one of the two is not hydrogen,
X⁵ is S or C(CH₃)₂,
X³ is S,
X⁴ is N or C—R⁶, preferably N,
R³ and R⁴ are independently C₁- to Ca-alkyl, C₃- to C₆-alkenyl, C₄- to C₇-cycloalkyl, C₇- to C₁₀-aralkyl or C₆- to C₁₀-aryl or
R¹, R⁴ form a —CH₂—CH₂—CH₂—CH₂—, —CH₂—CH₂—CH₂—CH₂—CH₂— or CH₂—CH₂—O—CH₂—CH₂— bridge,
R⁵ is C₁- to Ca-alkyl or C₆- to C₁₀-aryl,
R⁶ is hydrogen or cyano,
R¹⁵ is hydrogen, C₁- to C₈-alkyl, C₃- to C₆-alkenyl, C₄- to C₇-cycloalkyl or C₇- to C₁₀-aralkyl,
R¹⁶ is hydrogen, C₁- to C₄-alkyl, C₅- to C₆-cycloalkyl or C₆-aryl,
R¹⁷ and R¹⁸ are independently hydrogen, chlorine, methyl or methoxy, where preferably just one of the two is not hydrogen,
n and m are both 1 and
An⁻ represents the equivalent of one anion.

In a further embodiment of the invention,
Q¹ is cyano or, together with R¹², forms a —CH₂—CH₂—CH₂— bridge,
Q² and Q³ are hydrogen,
the ring A together with R¹, N and X¹ and the atoms that connect them are a radical of the formulae

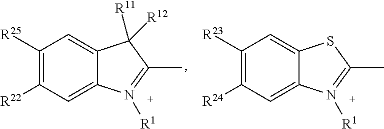

R¹ is methyl, ethyl, 1-propyl, 1-butyl, benzyl or cyanoethyl,
R¹¹ and R¹² are each independently methyl, ethyl or benzyl or together form a —CH₂—CH₂—CH₂—CH₂— or —CH₂—CH₂—CH₂—CH₂—CH₂— bridge,
R²¹ is hydrogen, chlorine, cyano, methoxycarbonyl, ethoxycarbonyl, methyl or methoxy,
R²² and R²⁴ are hydrogen,
R²³ is hydrogen, chlorine, cyano, methyl or methoxy,
the ring B together with R², N and X² and the atoms that connect them are a radical of the formula

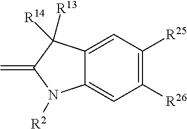

R² is methyl, ethyl, 1-propyl, 1-butyl, benzyl or cyanoethyl,
R¹³ and R¹⁴ are each independently methyl, ethyl or benzyl or together form a —CH₂—CH₂—CH₂—CH₂— or —CH₂—CH—CH₂—CH₂—CH₂— bridge,
R²⁵ is hydrogen, chlorine, cyano, methoxycarbonyl, ethoxycarbonyl, methyl or methoxy,
R²⁶ is hydrogen,
X³ is S,
X⁴ is N,
R³ and R⁴ are each independently methyl, ethyl, 1-propyl, 1-butyl, 1-octyl, cyclohexyl or benzyl or
R³, R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is methyl, ethyl, tert-butyl, phenyl, 4-methylphenyl or 4-methoxyphenyl,
R¹⁵ is hydrogen, methyl, ethyl, 1-propyl, 1-butyl, 1-octyl or benzyl,
R¹⁶ is hydrogen, methyl or phenyl,
R¹⁷ is hydrogen, chlorine or methyl,
R¹⁸ is hydrogen and
An⁻ represents the equivalent of one anion.

Alkyl and alkoxy radicals may be unbranched or branched. They may also bear further radicals such as fluorine, chlorine, alkoxy, cyano or alkoxycarbonyl. Examples are methyl, ethyl, 1- or 2-propyl, 1- or 2-butyl, tert-butyl, I-octyl, chloroethyl, cyanoethyl, methoxyethyl or trifluoromethyl.

Cycloalkyl radicals are preferably cyclopentyl or cyclohexyl.

Aralkyl radicals may be unbranched or branched in the alkyl moiety and bear further radicals in the aryl moiety. Examples are benzyl, phenethyl, 2- or 3-phenylpropyl, 4-chlorobenzyl, 4-methoxybenzyl. Aryl radicals are phenyl or naphthyl, preferably phenyl, and may bear further radicals such as fluorine, chlorine, alkoxy, nitro, cyano or alkoxycarbonyl. Examples of such substituted phenyl radicals are 2-, 3- or 4-fluorophenyl, 2-, 3- or 4-chlorophenyl, 2-, 3- or 4-methylphenyl, 2-, 3- or 4-methoxyphenyl, 2-, 3- or 4-cyanophenyl, biphenylyl, 3,4-dichlorophenyl, 3,4-dimethylphenyl, 3,4-dimethoxyphenyl.

In one embodiment of the invention, the photopolymer composition according to the invention comprises matrix polymers and at least one writing monomer.

In a further embodiment of the invention, the photopolymer composition additionally comprises a coinitiator.

Suitable coinitiators are ammonium alkylarylborates which, together with the dyes according to the invention, form a type II photoinitiator (Norrish type II) are described in principle in EP 0 223 587. Suitable ammonium alkylarylborates of this kind are, for example (Cunningham et al., RadTech'98 North America UV/EB Conference Proceedings, Chicago, Apr. 19-22, 1998): tetrabutylammonium triphenylhexylborate, tetrabutylammonium triphenylbutylborate, tetrabutylammonium trinaphthylhexylborate, tetrabutylammonium tris(4-tert-butyl)phenylbutylborate, tetrabutylammonium tris(3-fluorophenyl)hexylborate hexylborate ([191726-69-9], CGI 7460, product from BASF SE, Basle, Switzerland), 1-methyl-3-octylimidazolium dipentyldiphenylborate and tetrabutylammonium tris(3-chloro-4-methylphenyl)hexylborate ([1147315-11-4], CGI 909, product from BASF SE, Basle, Switzerland).

Other suitable borates are known from WO 2015/055576 A1 and may find use as coinitiators in the context of the invention.

Further suitable coinitiators are electron acceptors, for example tris(trihalomethyl)triazine and/or derivatives thereof, especially substituted bis(trihalomethyl)triazines, as described, for example, in JP 2008201912, EP 1 457 190 A1, EP 0 332 042, U.S. Pat. No. 3,987,037 or U.S. Pat. No. 5,489,499. In the context of the invention, the photoinitiator system may thus consist of at least one ammonium alkylarylborate as described above and/or at least one electron acceptor, for example a tris(trihalomethyl)triazine and/or derivatives thereof, especially a substituted bis(trihalomethyl)triazine. It is also possible for further electron acceptors known from the prior art (US000005500453A1, WO2006138637A1), for example iodonium or sulphonium salts, to be part of the photoinitiator system. It is also possible to use any desired mixtures of the coinitiators mentioned.

The invention likewise provides photopolymers comprising a photopolymer composition according to the invention.

The matrix polymers of the photopolymer according to the invention may be particularly in a crosslinked state and more preferably in a three-dimensionally crosslinked state.

It is also advantageous for the matrix polymers to be polyurethanes, in which case the polyurethanes may be obtainable in particular by reacting at least one polyisocyanate component a) with at least one isocyanate-reactive component b).

The polyisocyanate component a) preferably comprises at least one organic compound having at least two NCO groups. These organic compounds may especially be monomeric di- and triisocyanates, polyisocyanates and/or NCO-functional prepolymers. The polyisocyanate component a) may also contain or consist of mixtures of monomeric di- and triisocyanates, polyisocyanates and/or NCO-functional prepolymers.

Monomeric di- and triisocyanates used may be any of the compounds that are well known per se to those skilled in the art, or mixtures thereof. These compounds may have aromatic, araliphatic, aliphatic or cycloaliphatic structures. The monomeric di- and triisocyanates may also comprise minor amounts of monoisocyanates, i.e. organic compounds having one NCO group.

Examples of suitable monomeric di- and triisocyanates are butane 1,4-diisocyanate, pentane 1,5-diisocyanate, hexane 1,6-diisocyanate (hexamethylene diisocyanate, HDI), 2,2,4-trimethylhexamethylene diisocyanate and/or 2,4,4-trimethylhexamethylene diisocyanate (TMDI), isophorone diisocyanate (IPDI), 1,8-diisocyanato-4-(isocyanatomethyl)octane, bis(4,4′-isocyanatocyclohexyl)methane and/or bis(2′,4-isocyanatocyclohexyl)methane and/or mixtures thereof having any isomer content, cyclohexane 1,4-diisocyanate, the isomeric bis(isocyanatomethyl)cyclohexanes, 2,4- and/or 2,6-diisocyanato-1-methylcyclohexane (hexahydrotolylene 2,4- and/or 2,6-diisocyanate, H₆-TDI), phenylene 1,4-diisocyanate, tolylene 2,4- and/or 2,6-diisocyanate (TDI), naphthylene 1,5-diisocyanate (NDI), diphenylmethane 2,4′- and/or 4,4′-diisocyanate (MDI), 1,3-bis(isocyanatomethyl)benzene (XDI) and/or the analogous 1,4 isomers or any desired mixtures of the aforementioned compounds.

Suitable polyisocyanates are compounds which have urethane, urea, carbodiimide, acylurea, amide, isocyanurate, allophanate, biuret, oxadiazinetrione, uretdione and/or iminooxadiazinedione structures and are obtainable from the aforementioned di- or triisocyanates.

More preferably, the polyisocyanates are oligomerized aliphatic and/or cycloaliphatic di- or triisocyanates, it being possible to use especially the above aliphatic and/or cycloaliphatic di- or triisocyanates.

Very particular preference is given to polyisocyanates having isocyanurate, uretdione and/or iminooxadiazinedione structures, and biurets based on HDI or mixtures thereof.

Suitable prepolymers contain urethane and/or urea groups, and optionally further structures formed through modification of NCO groups as specified above. Prepolymers of this kind are obtainable, for example, by reaction of the abovementioned monomeric di- and triisocyanates and/or polyisocyanates a1) with isocyanate-reactive compounds b1).

Isocyanate-reactive compounds b1) used may be alcohols, amino or mercapto compounds, preferably alcohols. These may especially be polyols. Most preferably, isocyanate-reactive compound b1) used may be polyester polyols, polyether polyols, polycarbonate polyols, poly(meth)acrylate polyols and/or polyurethane polyols.

Suitable polyester polyols are, for example, linear polyester diols or branched polyester polyols, which can be obtained in a known manner by reaction of aliphatic, cycloaliphatic or aromatic di- or polycarboxylic acids or anhydrides thereof with polyhydric alcohols of OH functionality ≥2. Examples of suitable di- or polycarboxylic acids are polybasic carboxylic acids such as succinic acid, adipic acid, suberic acid, sebacic acid, decanedicarboxylic acid, phthalic acid, terephthalic acid, isophthalic acid, tetrahydrophthalic acid or trimellitic acid, and acid anhydrides such as phthalic anhydride, trimellitic anhydride or succinic anhydride, or any desired mixtures thereof. The polyester polyols may also be based on natural raw materials such as castor oil. It is likewise possible that the polyester polyols are based on homo- or copolymers of lactones, which can preferably be obtained by addition of lactones or lactone mixtures, such as butyrolactone, ε-caprolactone and/or methyl-ε-caprolactone onto hydroxy-functional compounds such as polyhydric alcohols of OH functionality ≥2, for example of the hereinbelow mentioned type.

Examples of suitable alcohols are all polyhydric alcohols, for example the C₂-C₁₂ diols, the isomeric cyclohexanediols, glycerol or any desired mixtures thereof.

Suitable polycarbonate polyols are obtainable in a manner known per se by reaction of organic carbonates or phosgene with diols or diol mixtures.

Suitable organic carbonates are dimethyl, diethyl and diphenyl carbonate.

Suitable diols or mixtures comprise the polyhydric alcohols of OH functionality ≥2 mentioned per se in the context of the polyester segments, preferably butane-1,4-diol, hexane-1,6-diol and/or 3-methylpentanediol. It is also possible to convert polyester polyols to polycarbonate polyols.

Suitable polyether polyols are polyaddition products, optionally of blockwise structure, of cyclic ethers onto OH- or NH-functional starter molecules.

Suitable cyclic ethers are, for example, styrene oxides, ethylene oxide, propylene oxide, tetrahydrofuran, butylene oxide, epichlorohydrin, and any desired mixtures thereof.

Starters used may be the polyhydric alcohols of OH functionality ≥2 mentioned per se in the context of the polyester polyols, and also primary or secondary amines and amino alcohols.

Preferred polyether polyols are those of the aforementioned type based exclusively on propylene oxide, or random or block copolymers based on propylene oxide with further 1-alkylene oxides. Particular preference is given to propylene oxide homopolymers and random or block copolymers containing oxyethylene, oxypropylene and/or oxybutylene units, where the proportion of the oxypropylene units based on the total amount of all the oxyethylene, oxypropylene and oxybutylene units amounts to at least 20% by weight, preferably at least 45% by weight. Oxypropylene and oxybutylene here encompasses all the respective linear and branched C₃ and C₄ isomers.

Additionally suitable as constituents of the polyol component b1), as polyfunctional, isocyanate-reactive compounds, are also low molecular weight (i.e. with molecular weights ≤500 g/mol), short-chain (i.e. containing 2 to 20 carbon atoms), aliphatic, araliphatic or cycloaliphatic di-, tri- or polyfunctional alcohols.

These may, for example, in addition to the abovementioned compounds, be neopentyl glycol, 2-ethyl-2-butylpropanediol, trimethylpentanediol, positionally isomeric diethyloctanediols, cyclohexanediol, 1,4-cyclohexanedimethanol, 1,6-hexanediol, 1,2- and 1,4-cyclohexanediol, hydrogenated bisphenol A, 2,2-bis(4-hydroxycyclohexyl)propane or 2,2-dimethyl-3-hydroxypropionic acid, 2,2-dimethyl-3-hydroxypropyl ester. Examples of suitable triols are trimethylolethane, trimethylolpropane or glycerol. Suitable higher-functionality alcohols are di(trimethylolpropane), pentaerythritol, dipentaerythritol or sorbitol.

It is especially preferable when the polyol component is a difunctional polyether, polyester, or a polyether-polyester block copolyester or a polyether-polyester block copolymer having primary OH functions.

It is likewise possible to use amines as isocyanate-reactive compounds b1). Examples of suitable amines are ethylenediamine, propylenediamine, diaminocyclohexane, 4,4′-dicyclohexylmethanediamine, isophoronediamine (IPDA), difunctional polyamines, for example the Jeffamines, amine-terminated polymers, especially having number-average molar masses ≤10 000 g/mol. Mixtures of the aforementioned amines can likewise be used.

It is likewise possible to use amino alcohols as isocyanate-reactive compounds b1). Examples of suitable amino alcohols are the isomeric aminoethanols, the isomeric aminopropanols, the isomeric aminobutanols and the isomeric aminohexanols, or any desired mixtures thereof.

All the aforementioned isocyanate-reactive compounds b1) can be mixed with one another as desired.

It is also preferable when the isocyanate-reactive compounds b1) have a number-average molar mass of ≥200 and ≤10 000 g/mol, further preferably ≥500 and ≤8000 g/mol and most preferably ≥800 and ≤5000 g/mol. The OH functionality of the polyols is preferably 1.5 to 6.0, more preferably 1.8 to 4.0.

The prepolymers of the polyisocyanate component a) may especially have a residual content of free monomeric di- and triisocyanates of <1% by weight, more preferably <0.5% by weight and most preferably <0.3% by weight.

It is optionally also possible that the polyisocyanate component a) contains, entirely or in part, organic compound whose NCO groups have been fully or partly reacted with blocking agents known from coating technology. Examples of blocking agents are alcohols, lactams, oximes, malonic esters, pyrazoles, and amines, for example butanone oxime, diisopropylamine, diethyl malonate, ethyl acetoacetate, 3,5-dimethylpyrazole, ε-caprolactam, or mixtures thereof.

It is especially preferable when the polyisocyanate component a) comprises compounds having aliphatically bonded NCO groups, aliphatically bonded NCO groups being understood to mean those groups that are bonded to a primary carbon atom. The isocyanate-reactive component b) preferably comprises at least one organic compound having an average of at least 1.5 and preferably 2 to 3 isocyanate-reactive groups. In the context of the present invention, isocyanate-reactive groups are regarded as being preferably hydroxyl, amino or mercapto groups.

The isocyanate-reactive component may especially comprise compounds having a numerical average of at least 1.5 and preferably 2 to 3 isocyanate-reactive groups.

Suitable polyfunctional isocyanate-reactive compounds of component b) are for example the above-described compounds b1).

In a further preferred embodiment, the writing monomer c) comprises or consists of at least one mono- and/or one multifunctional writing monomer. Further preferably, the writing monomer may comprise or consist of at least one mono- and/or one multifunctional (meth)acrylate writing monomer. Most preferably, the writing monomer may comprise or consist of at least one mono- and/or one multifunctional urethane (meth)acrylate.

Suitable acrylate writing monomers are especially compounds of the general formula (VI)

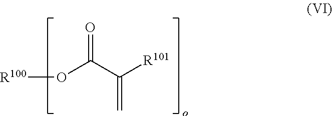

in which o≥1 and n≤4 and R¹⁰⁰ is a linear, branched, cyclic or heterocyclic organic moiety which is unsubstituted or else optionally substituted by heteroatoms and/or R¹⁰¹ is hydrogen or a linear, branched, cyclic or heterocyclic organic moiety which is unsubstituted or else optionally substituted by heteroatoms. More preferably, R¹⁰¹ is hydrogen or methyl and/or R¹⁰⁰ is a linear, branched, cyclic or heterocyclic organic moiety which is unsubstituted or else optionally substituted by heteroatoms.

Acrylates and methacrylates refer in the present context, respectively, to esters of acrylic acid and methacrylic acid. Examples of acrylates and methacrylates usable with preference are phenyl acrylate, phenyl methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2-naphthyl methacrylate, 1,4-bis(2-thionaphthyl)-2-butyl acrylate, 1,4-bis(2-thionaphthyl)-2-butyl methacrylate, bisphenol A diacrylate, bisphenol A dimethacrylate, and the ethoxylated analogue compounds thereof, N-carbazolyl acrylates.

Urethane acrylates are understood in the present context to mean compounds having at least one acrylic ester group and at least one urethane bond. Compounds of this kind can be obtained, for example, by reacting a hydroxy-functional acrylate or methacrylate with an isocyanate-functional compound.

Examples of isocyanate-functional compounds usable for this purpose are monoisocyanates, and the monomeric diisocyanates, triisocyanates and/or polyisocyanates mentioned under a). Examples of suitable monoisocyanates are phenyl isocyanate, the isomeric methylthiophenyl isocyanates, the isomeric phenylthiophenyl isocyanates. Di-, tri- or polyisocyanates have been mentioned above, and also triphenylmethane 4,4′,4″-triisocyanate and tris(p-isocyanatophenyl) thiophosphate or derivatives thereof with urethane, urea, carbodiimide, acylurea, isocyanurate, allophanate, biuret, oxadiazinetrione, uretdione, iminooxadiazinedione structure and mixtures thereof. Preference is given to aromatic di-, tri- or polyisocyanates.

Useful hydroxy-functional acrylates or methacrylates for the preparation of urethane acrylates include, for example, compounds such as 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mono(meth)acrylates, for example Tone® M100 (Dow, Schwalbach, Del.), 2-hydroxypropyl (meth)acrylate, 4-hydroxybutyl (meth)acrylate, 3-hydroxy-2,2-dimethylpropyl (meth)acrylate, hydroxypropyl (meth)acrylate, 2-hydroxy-3-phenoxypropyl acrylate, the hydroxy-functional mono-, di- or tetraacrylates of polyhydric alcohols such as trimethylolpropane, glycerol, pentaerythritol, dipentaerythritol, ethoxylated, propoxylated or alkoxylated trimethylolpropane, glycerol, pentaerythritol, dipentaerythritol or the technical mixtures thereof. Preference is given to 2-hydroxyethyl acrylate, hydroxypropyl acrylate, 4-hydroxybutyl acrylate and poly(ε-caprolactone) mono(meth)acrylate.

It is likewise possible to use the fundamentally known hydroxyl-containing epoxy (meth)acrylates having OH contents of 20 to 300 mg KOH/g or hydroxyl-containing polyurethane (meth)acrylates having OH contents of 20 to 300 mg KOH/g or acrylated polyacrylates having OH contents of 20 to 300 mg KOH/g and mixtures thereof, and mixtures with hydroxyl-containing unsaturated polyesters and mixtures with polyester (meth)acrylates or mixtures of hydroxyl-containing unsaturated polyesters with polyester (meth)acrylates.

Preference is given especially to urethane acrylates obtainable from the reaction of tris(p-isocyanatophenyl) thiophosphate and/or m-methylthiophenyl isocyanate and/or m- or o-phenylthiophenyl isocyanates with alcohol-functional acrylates such as hydroxyethyl (meth)acrylate, hydroxypropyl (meth)acrylate and/or hydroxybutyl (meth)acrylate.

It is likewise possible that the writing monomer comprises or consists of further unsaturated compounds such as α,β-unsaturated carboxylic acid derivatives, for example maleates, fumarates, maleimides, acrylamides, and also vinyl ethers, propenyl ethers, allyl ethers and compounds containing dicyclopentadienyl units, and also olefinically unsaturated compounds, for example styrene, α-methylstyrene, vinyltoluene and/or olefins.

Photoinitiators of component d) are compounds activatable typically by means of actinic radiation, which can trigger polymerization of the writing monomers. In the case of the photoinitiators, a distinction can be made between unimolecular (type I) and bimolecular (type II) initiators. In addition, they are distinguished by their chemical nature as photoinitiators for free-radical, anionic, cationic or mixed types of polymerization.

In the context of this invention, type II photoinitiators are used.

Type II photoinitiators (Norrish type II) for free-radical polymerization consist of a dye as sensitizer and a coinitiator, and undergo a bimolecular reaction on irradiation with light matched to the dye. First of all, the dye absorbs a photon and transfers energy from an excited state to the coinitiator. The latter releases the polymerization-triggering free radicals through electron or proton transfer or direct hydrogen abstraction.

Preferred anions An⁻ in the chain-substituted cyanine dyes according to the invention are especially C₈- to C₂₅-alkanesulphonate, preferably C₁₃- to C₂₅-alkanesulphonate, C₃- to C₁₈-perfluoroalkanesulphonate, C₄- to C₁₈-perfluoroalkanesulphonate bearing at least 3 hydrogen atoms in the alkyl chain, C₉- to C₂₅-alkanoate, C₉- to C₂₅-alkenoate, C₈- to C₂₅-alkylsulphate, preferably C₁₃- to C₂₅-alkylsulphate, C₈- to C₂₅-alkenylsulphate, preferably C₁₃- to C₂₅-alkenylsulphate, C₃- to C₁₈-perfluoroalkylsulphate, C₄- to C₁₈-perfluoroalkylsulphate bearing at least 3 hydrogen atoms in the alkyl chain, polyether sulphates based on at least 4 equivalents of ethylene oxide and/or 4 equivalents of propylene oxide, bis(C₄- to C₂₅-alkyl, C₅- to C₇-cycloalkyl, C₃- to C₈-alkenyl or C₇- to C₁₁-aralkyl)sulphosuccinate, bis-C₂- to C₁₀-alkylsulphosuccinate substituted by at least 8 fluorine atoms, C₈- to C₂₅-alkylsulphoacetates, benzenesulphonate substituted by at least one radical from the group of halogen, C₄- to C₂₅-alkyl, perfluoro-C₁- to C₈-alkyl and/or C₁- to C₁₂-alkoxycarbonyl, naphthalene- or biphenylsulphonate optionally substituted by nitro, cyano, hydroxyl, C₁- to C₂₅-alkyl, C₁- to C₁₂-alkoxy, amino, C₁- to C₁₂-alkoxycarbonyl or chlorine, benzene-, naphthalene- or biphenyldisulphonate optionally substituted by nitro, cyano, hydroxyl, C₁- to C₂₅-alkyl, C₁- to C₁₂-alkoxy, C₁- to C₁₂-alkoxycarbonyl or chlorine, benzoate substituted by dinitro, C₆- to C₂₅-alkyl, C₄- to C₁₂-alkoxycarbonyl, benzoyl, chlorobenzoyl or tolyl, the anion of naphthalenedicarboxylic acid, diphenyl ether disulphonate, sulphonated or sulphated, optionally at least monounsaturated C₈ to C₂₅ fatty acid esters of aliphatic C₁ to C₈ alcohols or glycerol, bis(sulpho-C₂- to C₆-alkyl) C₃- to C₁₂-alkanedicarboxylates, bis(sulpho-C₂- to C₆-alkyl) itaconates, (sulpho-C₂- to C₆-alkyl) C₆- to C₁₈-alkanecarboxylates, (sulpho-C₂- to C₆-alkyl) acrylates or methacrylates, triscatechol phosphate optionally substituted by up to 12 halogen radicals, an anion from the group of tetraphenylborate, cyanotriphenylborate, tetraphenoxyborate, C₄- to C₁₂-alkyltriphenylborate wherein the phenyl or phenoxy radicals may be substituted by halogen, C₁- to C₄-alkyl and/or C₁- to C₄-alkoxy, C₄- to C₁₂-alkyltrinaphthylborate, tetra-C₁- to C₂₀-alkoxyborate, 7,8- or 7,9-dicarbanidoundecaborate(1-) or (2-), which are optionally substituted on the boron and/or carbon atoms by one or two C₁- to C₁₂-alkyl or phenyl groups, dodecahydrodicarbadodecaborate(2-) or B—C₁- to C₁₂-alkyl-C-phenyldodecahydrodicarbadodecaborate(1-), where, in the case of polyvalent anions such as naphthalenedisulphonate, A⁻ represents one equivalent of this anion, and where the alkane and alkyl groups may be branched and/or may be substituted by halogen, cyano, methoxy, ethoxy, methoxycarbonyl or ethoxycarbonyl.

It is also preferable when the anion An⁻ of the dye has an AClogP in the range from 1 to 30, more preferably in the range from 1 to 12 and especially preferably in the range from 1 to 6.5. AClogP is calculated according to J. Comput. Aid. Mol. Des. 2005, 19, 453; Virtual Computational Chemistry Laboratory, http://www.vcclab.org.

When the cationic chain-substituted cyanine dye has the formula (VII), the counterions may be as desired, excluding dibenzylsulphosuccinate as anion.

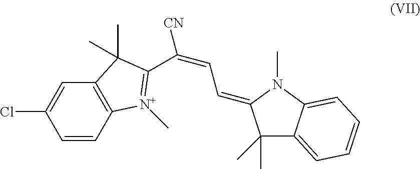 [SMILES: CN1/C(=C\C=C(\C#N)C2=[N+](C)c3ccc(Cl)cc3C2(C)C)C(C)(C)c2ccccc21]

It may be advantageous to use mixtures of these photoinitiators. According to the radiation source used, the type and concentration of photoinitiator has to be adjusted in the manner known to those skilled in the art. Further details are described, for example, in P. K. T. Oldring (Ed.), Chemistry & Technology of UV & EB Formulations For Coatings, Inks & Paints, Vol. 3, 1991, SITA Technology, London, p. 61-328.

It is most preferable when the photoinitiator comprises a combination of dyes whose absorption spectra at least partly cover the spectral range from 400 to 800 nm, with at least one coinitiator matched to the dyes.

It is also preferable when at least one photoinitiator suitable for a laser light colour selected from blue, green, yellow and red is present in the photopolymer composition.

It is also further preferable when the photopolymer composition contains one suitable photoinitiator each for at least two laser light colours selected from blue, green, yellow and red.

Finally, it is most preferable when the photopolymer composition contains one suitable photoinitiator for each of the laser light colours blue, green and red.

In a further preferred embodiment, the photopolymer composition additionally contains urethanes as additives, in which case the urethanes may especially be substituted by at least one fluorine atom.

Preferably, the urethanes may have the general formula (VIII)

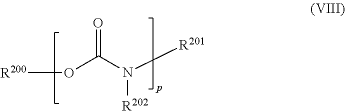

in which p≥1 and p≤8 and R²⁰⁰, R²⁰¹ and R²⁰² are each a linear, branched, cyclic or heterocyclic organic moiety which is unsubstituted or else optionally substituted by heteroatoms and/or R²⁰¹, R²⁰² are each independently hydrogen, in which case preferably at least one of the R²⁰⁰, R²⁰¹, R²⁰² moieties is substituted by at least one fluorine atom and, more preferably, R²⁰⁰ is an organic radical having at least one fluorine atom. More preferably, R²⁰¹ is a linear, branched, cyclic or heterocyclic organic moiety which is unsubstituted or else optionally substituted by heteroatoms, for example fluorine.

The present invention further provides a photopolymer comprising matrix polymers, a writing monomer and a photoinitiator, wherein the photoinitiator comprises a coinitiator and a cationic dye and the cationic dye is a chain-substituted cyanine dye of the formula (I)

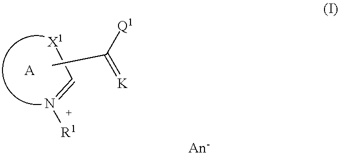

and the radicals are defined as described above.

Dyes of the formula (I) in which K is a radical of the formula (II) with n=0 and m=1 or (IV) are known, for example, from DE 1 073 662. Dyes of the formula (I) in which K is a radical of the formula (II) andn=m=0 are known, for example, from DE 2 617 345.

Dyes of the formula (I) in which K is a radical of the formula (III) can be prepared, for example, by reacting aldehydes of the formula

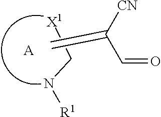

with heterocycles of the formula

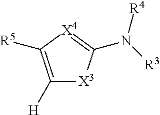

or by reaction of methylene bases of the formula

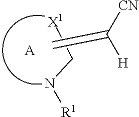

with heterocyclic aldehydes of the formula

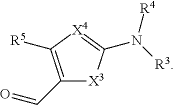

The reaction can be effected, for example, under acidic conditions in the presence of protic acids or inorganic acid chlorides. Suitable protic acids are, for example, sulphuric acid and sulphonic acids such as methanesulphonic acid, benzenesulphonic acid, toluenesulphonic acid, dodecylbenzenesulphonic acid; inorganic acid chlorides are, for example, phosgene, thionyl chloride or phosphorous oxychloride. Solvents in the case of use of protic acids are polar solvents, for example alcohols such as ethanol, carboxylic acids such as glacial acetic acid, aprotic solvents such as dimethyl sulphoxide, N-ethylpyrrolidone, dimethylformamide. Solvents in the case of use of inorganic acid chlorides are aromatics such as toluene, xylene, chlorinated solvents such as trichloromethane, chlorobenzene.

The reaction is effected at room temperature up to the boiling point of the medium, preferably at 30 to 90° C.

Methylene bases of the formula

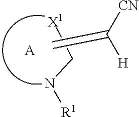

are known from DD 294 246 or can be prepared analogously.

Aldehydes of the formula

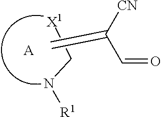

are known from J. Amer. Chem. Soc. 2009, 131, 12960 or can be prepared analogously.

Heterocycles of the formula

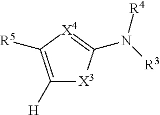

are known from Z. Chem. 1968, 8, 182 or Tetrahedron 2005, 61, 903 or can be prepared analogously.

Heterocyclic aldehydes of the formula

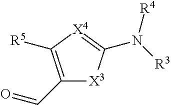

are known from U.S. Pat. No. 3,573,289 or J. Chem. Soc. Perkin Trans. 1990, 329 or can be prepared analogously.

The matrix polymers of the photopolymer according to the invention may be particularly in a crosslinked state and more preferably in a three-dimensionally crosslinked state.

It is also advantageous for the matrix polymers to be polyurethanes, in which case the polyurethanes may be obtainable in particular by reacting at least one polyisocyanate component with at least one isocyanate-reactive component.

The above remarks concerning further preferred embodiments of the photopolymer composition of the present invention also apply mutatis mutandis to the photopolymer of the present invention.

The invention also provides a holographic medium particularly in the form of a film comprising a photopolymer of the present invention or obtainable by using a photopolymer composition of the present invention. The invention yet further provides for the use of a photopolymer composition of the present invention in the production of holographic media.

In one preferred embodiment of the holographic medium according to the present invention, holographic information has been exposed into same.

The inventive holographic media can be processed into holograms by means of appropriate exposure processes for optical applications over the entire visible and in the near UV range (300-800 nm). The invention therefore likewise provides holograms comprising an inventive holographic medium. Visual holograms include all holograms which can be recorded by methods known to those skilled in the art. These include in-line (Gabor) holograms, off-axis holograms, full-aperture transfer holograms, white light transmission holograms (“rainbow holograms”), Denisyuk holograms, off-axis reflection holograms, edge-lit holograms and holographic stereograms, especially for production of optical elements, images or image representations. Preference is given to reflection holograms, Denisyuk holograms, transmission holograms.

Possible optical functions of the holograms which can be produced with the inventive photopolymer compositions correspond to the optical functions of light elements such as lenses, mirrors, deflecting mirrors, filters, diffuser lenses, diffraction elements, diffusers, light guides, waveguides, projection lenses and/or masks. It is likewise possible for combinations of these optical functions to be combined in one hologram independently of each other. These optical elements frequently have a frequency selectivity according to how the holograms have been exposed and the dimensions of the hologram.

In addition, by means of the inventive media, it is also possible to produce holographic images or representations, for example for personal portraits, biometric representations in security documents, or generally of images or image structures for advertising, security labels, brand protection, branding, labels, design elements, decorations, illustrations, collectable cards, images and the like, and also images which can represent digital data, including in combination with the products detailed above. Holographic images can have the impression of a three-dimensional image, but they may also represent image sequences, short films or a number of different objects according to the angle from which and the light source with which (including moving light sources) etc. they are illuminated. Because of this variety of possible designs, holograms, especially volume holograms, constitute an attractive technical solution for the abovementioned application.

The present invention accordingly further provides for the use of an inventive holographic medium for recording of in-line, off-axis, full-aperture transfer, white light transmission, Denisyuk, off-axis reflection or edge-lit holograms and also of holographic stereograms, in particular for production of optical elements, images or image representations.

The present invention further also provides a process for producing a holographic medium by using the photopolymer of the present invention or the photopolymer composition of the present invention.

In a preferred embodiment of the process, the holographic medium is exposed with the aid of laser light, the exposure being effected by means of pulsed laser radiation.

The invention likewise provides a process for producing a hologram, in which the medium is exposed by using pulsed laser radiation.

In one embodiment of the process according to the invention, the pulse duration is ≤200 ns, preferably ≤100 ns, more preferably ≤60 ns. The pulse duration must not be less than 0.5 ns. Particular preference is given to a pulse duration of 4 ns.

The photopolymer compositions can especially be used for production of holographic media in the form of a film. In this case, a ply of a material or material composite transparent to light within the visible spectral range (transmission greater than 85% within the wavelength range from 400 to 780 nm) as carrier is coated on one or both sides, and a cover layer is optionally applied to the photopolymer ply or plies.

Preferred materials or material composites for the carrier are based on polycarbonate (PC), polyethylene terephthalate (PET), polybutylene terephthalate, polyethylene, polypropylene, cellulose acetate, cellulose hydrate, cellulose nitrate, cycloolefin polymers, polystyrene, polyepoxides, polysulphone, cellulose triacetate (CTA), polyamide, polymethylmethacrylate, polyvinyl chloride, polyvinyl butyral or polydicyclopentadiene or mixtures thereof. They are more preferably based on PC, PET and CTA. Material composites may be film laminates or coextrudates. Preferred material composites are duplex and triplex films formed according to one of the schemes A/B, A/B/A or A/B/C. Particular preference is given to PC/PET, PET/PC/PET and PC/TPU (TPU=thermoplastic polyurethane).

The materials or material composites of the carrier may be given a non-stick, antistatic, hydrophobized or hydrophilized finish on one or both sides. The modifications mentioned serve the purpose, on the side facing the photopolymer layer, of making the photopolymer ply detachable without destruction from the carrier. Modification of the opposite side of the carrier from the photopolymer ply serves to ensure that the inventive media satisfy specific mechanical demands which exist, for example, in the case of processing in roll laminators, especially in roll-to-roll processes.

The invention further provides dyes of the formula (I)

in which

K is a radical of the formula (III),

and

the further radicals have the definition given above.

Preference is given to dyes of the formula (I)

in which

K is a radical of the formula (III),

n and m are 0,
Q¹ is cyano or, together with R¹², forms a —CH₂—CH₂—CH₂— bridge,
the ring A together with R¹, N and X¹ and the atoms that connect them are a radical of the formulae

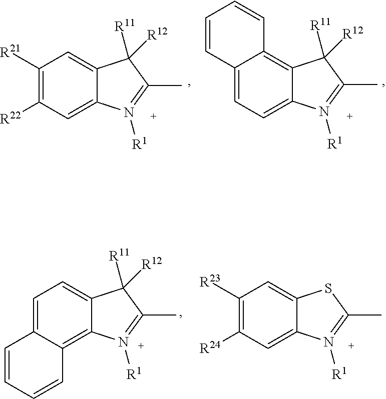

R¹ is C₁- to C₈-alkyl, C₃- to C₆-alkenyl, C₄- to C₇-cycloalkyl or C₇- to C₁₀-aralkyl,
R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy, where preferably just one of the two is not hydrogen,
R²³ and R²⁴ are independently hydrogen, chlorine, cyano, methyl, ethyl, methoxy or ethoxy, where preferably just one of the two is not hydrogen,
X³ is S,
X⁴ is N or C—R⁶, preferably N,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³, R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is C₁- to C₈-alkyl or C₆- to C₁₀-aryl,
R⁶ is hydrogen or cyano and

An⁻ represents the equivalent of one anion.

Particular preference is given to dyes of the formula (I)

in which

K is a radical of the formula (III),

n and m are 0,
Q¹ is cyano,
the ring A together with R¹, N and X¹ and the atoms that connect them are a radical of the formulae

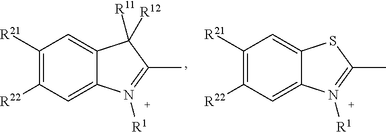

R¹ is methyl, ethyl, 1-propyl, 1-butyl, benzyl or cyanoethyl,
R¹¹ and R¹² are each independently methyl, ethyl or benzyl or together form a —CH₂—CH₂—CH₂—CH₂— or —CH₂—CH₂—CH₂—CH₂—CH₂— bridge,
R²¹ is hydrogen, chlorine, cyano, methoxycarbonyl, ethoxycarbonyl, methyl or methoxy,
R²² and R²⁴ are hydrogen,
R²³ is hydrogen, chlorine, cyano, methyl or methoxy,
X³ is S,
X⁴ is N or C—CN, preferably N,
R³ and R⁴ are each independently methyl, ethyl, 1-propyl, 1-butyl, 1-octyl, cyclohexyl or benzyl or
R³, R⁴ form a —CH₂—CH₂—CH₂—CH₂—, —CH₂—CH₂—CH₂—CH₂—CH₂— or —CH₂—CH—O—CH₂—CH₂— bridge,
R⁵ is methyl, ethyl, tert-butyl, phenyl, 4-methylphenyl or 4-methoxyphenyl, preferably tert-butyl or phenyl, and
An⁻ represents the equivalent of one anion.

Very particular preference is given to dyes of the formula (I)

in which

K is a radical of the formula (III),

n and m are 0,
Q¹ is cyano,
the ring A together with R¹, N and X¹ and the atoms that connect them are a radical of the formula

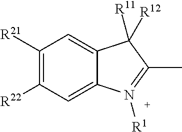

R¹ is methyl or benzyl,
R¹¹ and R¹² are methyl,
R²¹ is hydrogen, methoxycarbonyl or ethoxycarbonyl,
R²² is hydrogen,
X³ is S,
X⁴ is N,
R³ and R⁴ are the same and are methyl or ethyl or
R³; R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is phenyl and
An⁻ represents the equivalent of one anion.

The examples which follow serve to illustrate the invention, but without restricting it thereto.

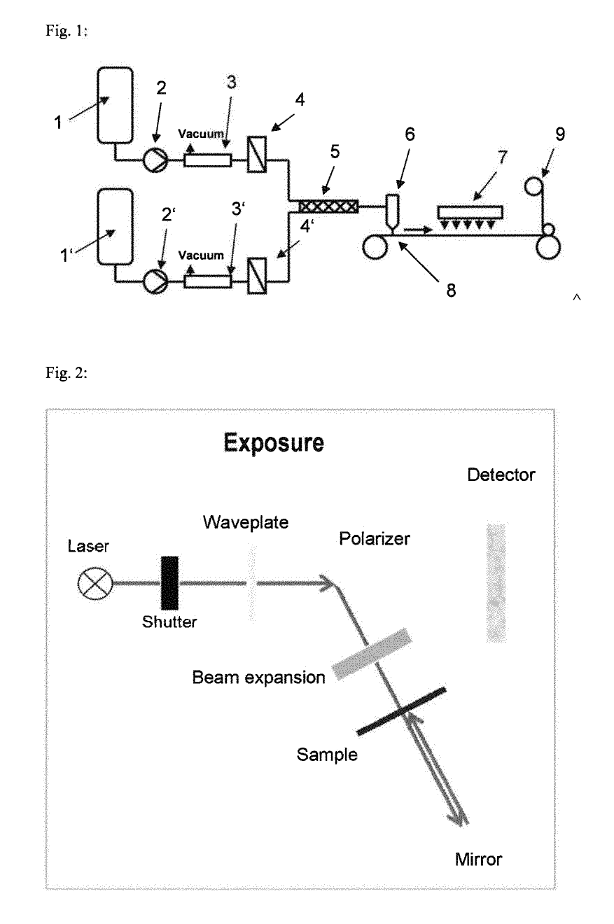

FIG. 1 describes a film coating system for production of holographic media on films.

FIG. 2 describes a holographic test setup for determining the diffraction efficiency after exposure, especially laser pulse exposure.

### EXAMPLES

Test Methods:

OH number:

Reported OH numbers were determined to DIN 53240-2.

NCO value:

Reported NCO values (isocyanate contents) were quantified to DIN EN ISO 11909.

Determination of Diffraction Efficiency in Laser Pulse Exposure:

To determine the diffraction efficiency in pulsed exposure, the Denisyuk hologram of a mirror was recorded in a sample consisting of a glass plate laminated with a photopolymer film. The substrate of a photopolymer film and the glass substrate faced the laser source and the mirror, respectively. The sample was exposed with its planar face perpendicular to the laser beam. The distance between the sample and the mirror was 3 cm.

The laser used was a Brilliant b pulsed laser from Quantel of France. The laser in question was a Q-switched Nd-YAG laser equipped with a module for frequency doubling to 532 nm. The single frequency mode was guaranteed by a seed laser. Coherence length was arithmetically about 1 m. Pulse duration was 4 ns and average power output was 3 watts at a pulse repetition rate of 10 Hz.

The electronically controlled shutter was used to ensure a single pulse exposure. The waveplate made it possible to rotate the polarization plane of the laser light and the subsequent polarizer was used to reflect the S-polarized portion of the laser light in the direction of the sample. The exposed area was adjusted by beam expansion. The waveplate and the beam expansion were adjusted such that the sample was given an exposure dose of 100 mJ/cm²/pulse.

To determine the diffraction efficiency, the samples were each exposed with exactly one pulse. After exposure, the sample was bleached on a light table.

A transmission spectrum was measured through the hologram of the bleached sample. An HR4000 spectrometer from Ocean Optics was used. The sample was placed perpendicularly to the light beam. The transmission spectrum showed a transmission collapse at a wavelength at which the Bragg condition was satisfied. The depth of the transmission collapse to the base line was evaluated as the diffraction efficiency DE of the Denisyuk hologram of the mirror.

Substances:

The solvents used were obtained commercially.
Desmorapid Z dibutyltin dilaurate [77-58-7], product from Bayer MaterialScience AG, Leverkusen, Germany.
Desmodur® N 3900, product from Bayer MaterialScience AG, Leverkusen, Germany, hexane diisocyanate-based polyisocyanate, proportion of iminooxadiazinedione at least 30%, NCO content: 23.5%
Fomrez UL 28 Urethanization catalyst, commercial product of Momentive Performance Chemicals, Wilton, Conn., USA.

### Example 1

1.00 g of the aldehyde

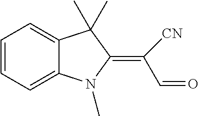 [SMILES: CN1/C(=C(/C#N)C=O)C(C)(C)c2ccccc21]

(prepared according to J. Amer. Chem. Soc. 2009, 131, 12960) and 1.08 g of the thiazole of the formula

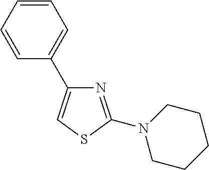 [SMILES: c1ccc(-c2csc(N3CCCCC3)n2)cc1]

(prepared according to R. Flaig, Thesis, University of Halle-Wittenberg, 1996) were dissolved in 15 ml of glacial acetic acid. 3 ml of acetic anhydride and 0.425 g of methanesulphonic acid were added while stirring and the mixture was stirred at 70° C. for 4 h. After cooling, the cherry-red solution was discharged into 60 ml of water and clarified with a little activated carbon. A solution of 1.53 g of sodium tetraphenylborate in 10 ml of methanol was slowly added dropwise with good stirring. The very thick suspension was filtered with suction. After washing with 20 ml of methanol/water 1:1, 20 ml of methanol/water 1:3 and 50 ml of water, the still-moist filtercake was stirred with 50 ml of methanol for 1 h. The mixture was filtered with suction again and washed with 2×10 ml of methanol and 30 ml of water. Drying at 50° C. under reduced pressure gave 2.16 g (63.2% of theory) of a pink powder of the formula

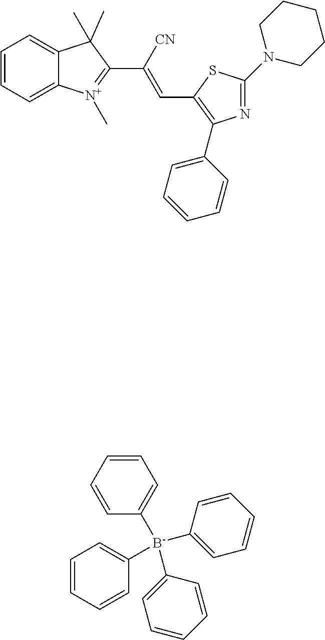 [SMILES: C[N+]1=C(/C(C#N)=C/c2sc(N3CCCCC3)nc2-c2ccccc2)C(C)(C)c2ccccc21 ; c1ccc([B-](c2ccccc2)(c2ccccc2)c2ccccc2)cc1]

λₘₐₓ (in CH₃CN)=538, 510 (sh) nm, ε=735101 mol⁻¹ cm⁻¹.

### Example 2

2.00 g of the methylene base of the formula

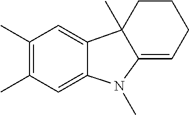

(prepared from 3,4-dimethylhydrazine and 2-methylcyclohexanone analogously to US2013/175509, followed by a methylation with dimethyl sulphate analogously to Chemistry of Heterocyclic Compounds (New York), 1982, 18, 923) and 1.77 g of the aldehyde of the formula

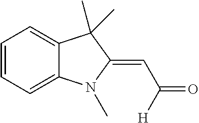

were dissolved in 14 ml of acetic anhydride while heating. 0.85 g of methanesulphonic acid was added dropwise while stirring over the course of 5 min. The mixture was stirred at 60° C. for 6 h. After cooling, the violet solution was discharged into 50 ml of water and clarified with a little activated carbon. A filtered solution of 3.02 g of sodium tetraphenylborate in 100 ml of water was added dropwise with good stirring. The fine violet suspension was filtered with suction and washed with 2×25 ml of water. After drying at 50° C. under reduced pressure, the violet powder was boiled three times with 20 ml of methanol and filtered off with suction after each cooling operation. Drying at 50° C. under reduced pressure gave 3.00 g (46.8% of theory) of a violet powder of the formula

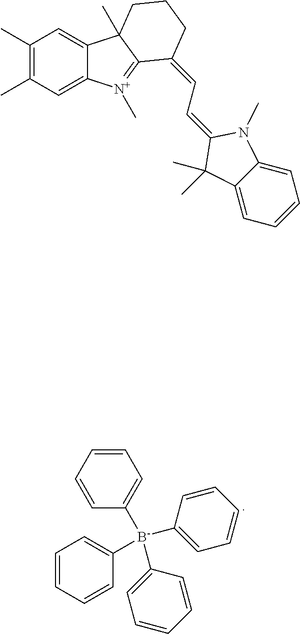 [SMILES: Cc1cc2c(cc1C)C1(C)CCC/C(=C/C=C3\N(C)c4ccccc4C3(C)C)C1=[N+]2C ; c1ccc([B-](c2ccccc2)(c2ccccc2)c2ccccc2)cc1]

λₘₐₓ (in CH₃CN)=543, 521 (sh) nm, ε=36810 l mol⁻¹ cm⁻¹.

### Example 3

4.03 g of the aldehyde of the formula

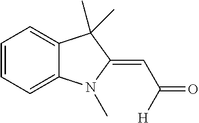

and 3.59 g of 2-cyanomethylbenzothiazole were stirred in 25 ml of acetic anhydride at 90° C. for 1.5 h. After cooling, the thick crystal slurry was discharged into 100 ml of water and diluted with 15 ml of methanol. The mixture was filtered with suction and washed with 200 ml of water until the water running off was colourless. Drying at 50° C. under reduced pressure gave 7.03 g (98.3% of theory) of an orange crystal powder of the formula

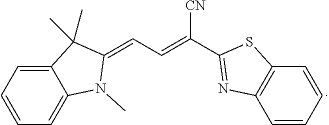 [SMILES: CN1/C(=C\C=C(/C#N)c2nc3ccccc3s2)C(C)(C)c2ccccc21]

To 2.50 g of this dye in 20 ml of anhydrous toluene was added 0.91 g of dimethyl sulphate, and the mixture was stirred at 90° C. for 16 h, with two further additions each of 0.91 g of dimethyl sulphate during this period. The thick suspension was filtered with suction and the filtercake was washed three times with 25 ml of toluene. While still moist, the product was twice stirred with 50 ml of toluene at 70° C. for 3 h, filtered off with suction each time and washed with 100 ml of toluene. Drying at 50° C. under reduced pressure gave 2.46 g (72.7% of theory) of a red crystal powder of the formula

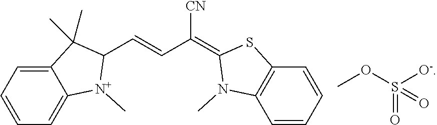

2.00 g of this dye were dissolved in 15 ml of methanol and filtered through a fluted filter. A solution of 1.43 g of sodium tetraphenylborate in 5 ml of methanol was added dropwise to the filtrate while stirring. The latter was filtered with suction and washed with 8×10 ml of methanol. The moist filtercake was then stirred in 25 ml of methanol at 45° C. for 3 h, filtered with suction again and washed with 6×10 ml of methanol. Drying at 50° C. under reduced pressure gave 1.94 g (67.8% of theory) of a red powder of the formula

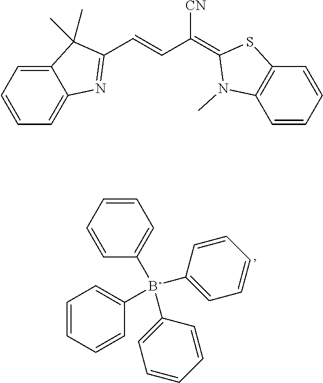 [SMILES: CN1/C(=C(C#N)\C=C\C2=Nc3ccccc3C2(C)C)Sc2ccccc21 ; c1ccc([B-](c2ccccc2)(c2ccccc2)c2ccccc2)cc1]

λₘₐₓ (in CH₃CN)=519, 500 (sh) nm, ε=91130 l mol⁻¹ cm⁻¹.

### Example 4

3.00 g of the cyanomethylene base of the formula

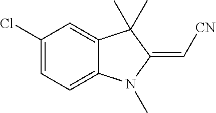

and 1.29 g of diphenylformamidine were stirred in 15 ml of acetic anhydride with addition of 0.62 g of methanesulphonic acid at 90° C. for 6 h. After cooling, the red solution was discharged onto 75 ml of water. 3 ml of methanol were added. After adding activated carbon, a little precipitated resin was filtered off. A solution of 2.25 g of sodium tetraphenylborate in 15 ml of water was added dropwise to the filtrate with good stirring. The thick suspension was filtered with suction and washed with 200 ml of water. After drying at 50° C. under reduced pressure, the dye was stirred in a mixture of 1 ml of methanol and 2 ml of glacial acetic acid for 3 h. Finally, 5 ml of water were slowly added dropwise. The mixture was filtered with suction and washed with a mixture of 10 ml of methanol and 3 ml of water and then with 100 ml of water. Drying at 50° C. under reduced pressure gave 2.36 g (46.1% of theory) of a vermilion-red powder of the formula

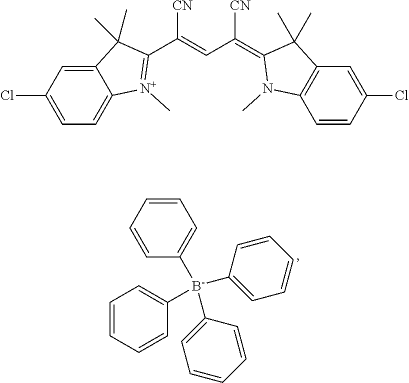 [SMILES: CN1/C(=C(C#N)\C=C(/C#N)C2=[N+](C)c3ccc(Cl)cc3C2(C)C)C(C)(C)c2cc(Cl)ccc21 ; c1ccc([B-](c2ccccc2)(c2ccccc2)c2ccccc2)cc1]

λₘₐₓ (in CH₃CN)=515 nm, ε=54870 l mol⁻¹ cm⁻¹.

### Example 5

Analogously to Example 6 of DE 1 073 662, 6.98 g of the cyanomethylene base of the formula

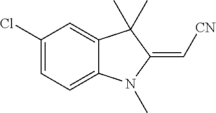

and 6.16 g of the aldehyde of the formula

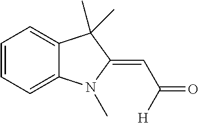

in 30 ml of anhydrous toluene were admixed gradually with 3.57 g of thionyl chloride while stirring. The mixture was then stirred at 100° C. for 1 h and cooled. 50 ml of toluene were added and the dye was filtered off with suction. It was stirred three times with 30 ml each time of toluene and filtered off with suction again each time. After drying at 50° C. under reduced pressure, the red dye was substantially dissolved in 100 ml of water. A solution of 12.38 g of sodium bis(2-ethylhexyl)sulphosuccinate in 100 ml of butyl acetate was added. The biphasic mixture was stirred for 1 h and then transferred into a separating funnel. The aqueous phase was discharged and the organic phase was washed four times with 40 ml of water. After the last water wash had been removed, the organic phase was diluted with 250 ml of butyl acetate and distilled on a rotary evaporator under reduced pressure until free of water. This also distilled off about 200 ml of butyl acetate, such that what was ultimately obtained was 150.1 g of a red solution of the dye of the formula

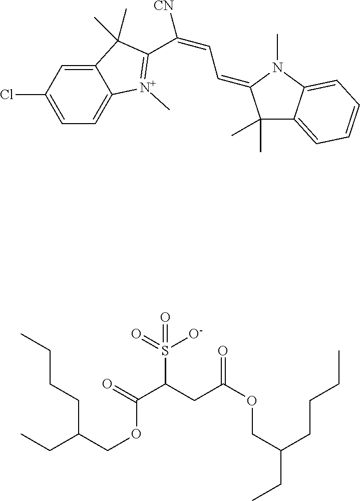

in butyl acetate, which was storage-stable.

A sample was taken and the rest of the solvent was drawn off under reduced pressure. Drying at 50° C. under reduced pressure gave the dye as a red resinous substance.

λₘₐₓ (in CH₃CN)=498 nm and 523 nm, ε=89580 (at 498 nm) and 99423 l mol⁻¹ cm⁻¹ (at 523 nm) 1 mol⁻¹ cm⁻¹.

With these spectroscopic data, it was possible to determine the concentration of the above solution to be 10.0%.

### Example 6

3.35 g of the compound of the formula

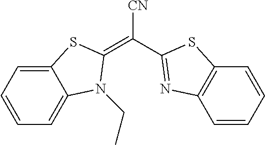 [SMILES: CCN1/C(=C(/C#N)c2nc3ccccc3s2)Sc2ccccc21]

known from DE 2 617 345, were heated to reflux in 40 ml of chlorobenzene while stirring, and 2.52 g of dimethyl sulphate were added. After 16 h at reflux, the mixture was cooled, filtered with suction and washed with 3×20 ml of chlorobenzene. Drying at 50° C. under reduced pressure gave 4.41 g (95% of theory) of the dye of the formula

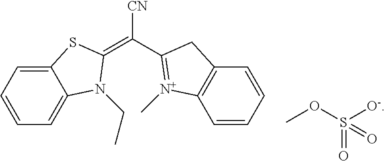

λₘₐₓ (in CH₃OH)=426 nm

2.31 g of this dye were dissolved in 15 ml of methanol. A solution of 1.72 g of sodium tetraphenylborate in 5 ml of methanol was added dropwise while stirring. The mixture was filtered with suction and washed with 20 ml of methanol. Drying at 50° C. under reduced pressure gave 2.71 g (80% of theory) of a yellow powder of the formula

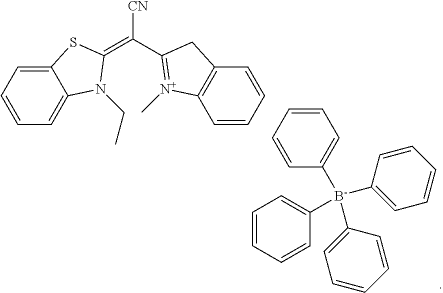 [SMILES: CCN1/C(=C(/C#N)C2=[N+](C)c3ccccc3C2)Sc2ccccc21 ; c1ccc([B-](c2ccccc2)(c2ccccc2)c2ccccc2)cc1]

### Example 7

3.00 g of the cyanomethylene base of the formula

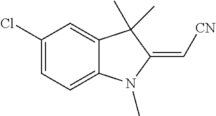 [SMILES: CN1/C(=C/C#N)C(C)(C)c2cc(Cl)ccc21]

and 1.70 g of malonaldehyde dianil hydrochloride were stirred in 15 ml of acetic anhydride at 90° C. for 20 min. After cooling, the blue suspension was discharged onto 75 ml of water. 3 ml of methanol were added. The mixture was filtered with suction and washed with water until the water running off was almost colourless. Drying at 50° C. under reduced pressure gave 3.16 g (91.1% of theory) of a green crystal powder of the formula

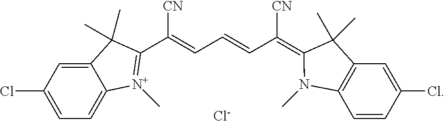 [SMILES: CN1\C(=C(C#N)/C=C/C=C(\C#N)C2=[N+](C)c3ccc(Cl)cc3C2(C)C)C(C)(C)c2cc(Cl)ccc21 ; [Cl-]]

λₘₐₓ (in CH₃CN)=616, 580 (sh) nm, ε=116965 l mol⁻¹ cm⁻¹.

2.00 g of this dye and 1.59 g of sodium bis(2-ethylhexyl)sulphosuccinate were stirred in a mixture of 30 ml of water and 30 ml of butyl acetate for 5 h. After transfer to a separating funnel, the aqueous phase was discharged. The organic phase was washed five times with 15 ml of water until, finally, no chloride ions were detectable with silver nitrate any longer in the water. The organic phase was dried with anhydrous magnesium sulphate. This gave 39.5 g of a solution which, via spectroscopic content determination, had a content of 8.0 percent of the dye of the formula

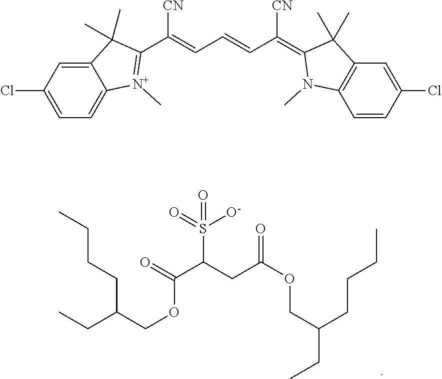 [SMILES: CN1\C(=C(C#N)/C=C/C=C(\C#N)C2=[N+](C)c3ccc(Cl)cc3C2(C)C)C(C)(C)c2cc(Cl)ccc21 ; CCCCC(CC)COC(=O)CC(C(=O)OCC(CC)CCCC)S(=O)(=O)[O-]]

### Example 8

0.80 g of the malonaldehyde of the formula

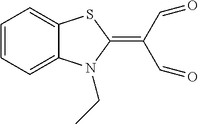 [SMILES: CCN1C(=C(C=O)C=O)Sc2ccccc21]

(prepared according to Coll. Czech. Chem. Commun. 1972, 37, 2273) and 1.80 g of 1,3,3-trimethyl-2-methyleneindoline were mixed. 3.16 g of phosphorus oxychloride were slowly added dropwise to the slurry with a syringe while stirring. The mixture turned blue immediately. The mixture was heated to 80° C. and kept at this temperature for 2 h. After cooling, the blue resin was dissolved by cautiously adding 10 ml of methanol in a water bath. A solution of 2.39 g of sodium tetraphenylborate in 10 ml of methanol was added dropwise to this solution while stirring. The mixture was filtered. 20 ml of water were slowly added dropwise to the filtrate while stirring, in the course of which the dye partly separated out as a resin. After dropwise addition of a solution of 4.5 g of sodium tetraphenylborate in 30 ml of water, the precipitation is complete and the product has solidified. The product was filtered off with suction and washed with 100 ml of methanol/water 1:2 and 100 ml of water. After drying at 50° C. under reduced pressure, the crude product was dissolved in 100 ml of acetone and precipitated by dropwise addition of 50 ml of water and filtered off with suction. This operation was repeated. The product was filtered off with suction and washed with 15 ml of acetone/water 2:1 and 10 ml of water. Drying at 50° C. under reduced pressure gave 1.68 g (41.4% of theory) of a copper oxide-coloured crystal powder of the formula

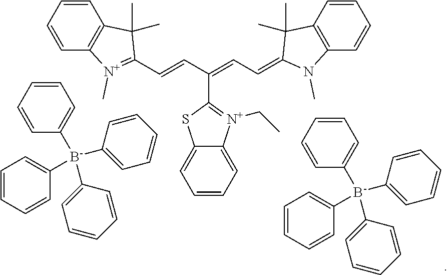 [SMILES: c1ccc([B-](c2ccccc2)(c2ccccc2)c2ccccc2)cc1 ; CC[n+]1c(C(=C\C=C2\N(C)c3ccccc3C2(C)C)/C=C/C2=[N+](C)c3ccccc3C2(C)C)sc2ccccc21 ; c1ccc([B-](c2ccccc2)(c2ccccc2)c2ccccc2)cc1]

λₘₐₓ (in CH₃CN)=605, 566 (sh) nm, ε=178480 l mol⁻¹ cm⁻¹.

Further dyes according to the invention can be found in the following table:

| Ex- | | | λₘₐₓ in |
|---|---|---|---|
| ample | Dye cation | An⁻ | CH₃CN |
| 9 | 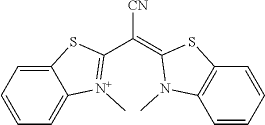 [SMILES: CN1/C(=C(/C#N)c2sc3ccccc3[n+]2C)Sc2ccccc21] | (C₆H₅)₄B⁻ | 424 nm |
| 10 | 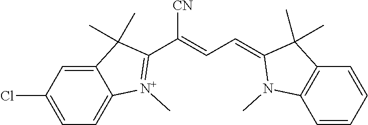 [SMILES: CN1/C(=C\C=C(/C#N)C2=[N+](C)c3ccc(Cl)cc3C2(C)C)C(C)(C)c2ccccc21] | C, 6; H, 5; N, 4 wt %. | 523, 498 (sh) nm |
| 11 | 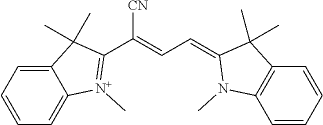 [SMILES: CN1/C(=C\C=C(/C#N)C2=[N+](C)c3ccccc3C2(C)C)C(C)(C)c2ccccc21] | (C₆H₅)₄B⁻ | 521, 497 nm |
| 12 | 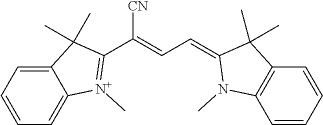 [SMILES: CN1/C(=C\C=C(/C#N)C2=[N+](C)c3ccccc3C2(C)C)C(C)(C)c2ccccc21] | Bis(2- ethylhexyl)- sulpho- succinate | 520, 497 nm |
| 13 | 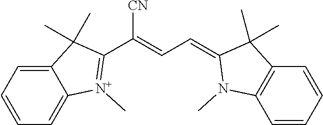 [SMILES: CN1/C(=C\C=C(/C#N)C2=[N+](C)c3ccccc3C2(C)C)C(C)(C)c2ccccc21] | (C₆H₅)₃ BCN⁻ | 521, 497 nm |
| 14 | 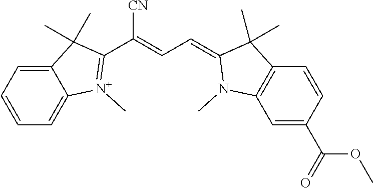 [SMILES: COC(=O)c1ccc2c(c1)N(C)/C(=C\C=C(/C#N)C1=[N+](C)c3ccccc3C1(C)C)C2(C)C] | Bis(2- ethylhexyl)- sulpho- succinate | 529, 503 (sh) nm |
| 15 | 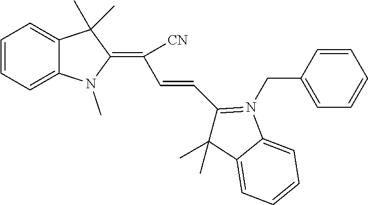 | (C₆H₅)₄B⁻ | 527, 500 nm |
| 16 | 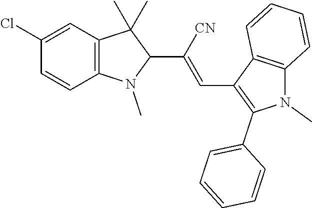 [SMILES: CN1c2ccc(Cl)cc2C(C)(C)C1/C(C#N)=C/c1c(-c2ccccc2)n(C)c2ccccc12] | (C₆H₅)₄B⁻ | 501 nm |
| 17 | 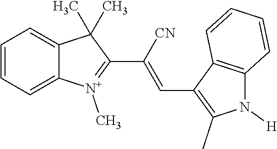 [SMILES: Cc1[nH]c2ccccc2c1/C=C(\C#N)C1=[N+](C)c2ccccc2C1(C)C] | (C₆H₅)₄B⁻ | 488 nm |

Comparative Dyes (Known from EP 2 633 544 A2):

Comparative Dye 1:

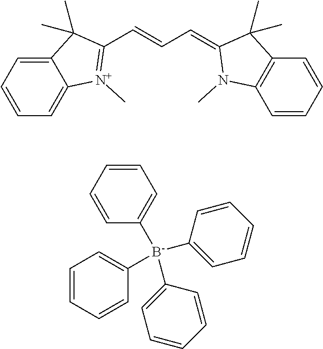 [SMILES: CN1/C(=C\C=C\C2=[N+](C)c3ccccc3C2(C)C)C(C)(C)c2ccccc21 ; c1ccc([B-](c2ccccc2)(c2ccccc2)c2ccccc2)cc1]

Comparative Dye 2:

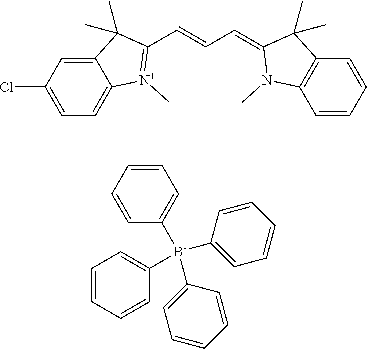 [SMILES: CN1/C(=C\C=C\C2=[N+](C)c3ccc(Cl)cc3C2(C)C)C(C)(C)c2ccccc21 ; c1ccc([B-](c2ccccc2)(c2ccccc2)c2ccccc2)cc1]

Comparative Dye 3:

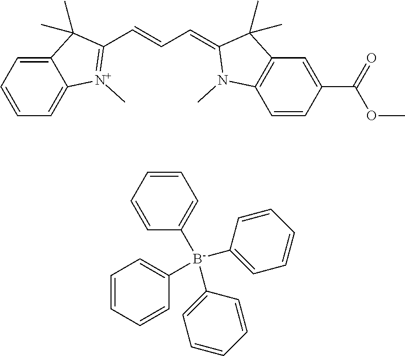 [SMILES: COC(=O)c1ccc2c(c1)C(C)(C)/C(=C/C=C/C1=[N+](C)c3ccccc3C1(C)C)N2C ; c1ccc([B-](c2ccccc2)(c2ccccc2)c2ccccc2)cc1]

Comparative Dye 4:

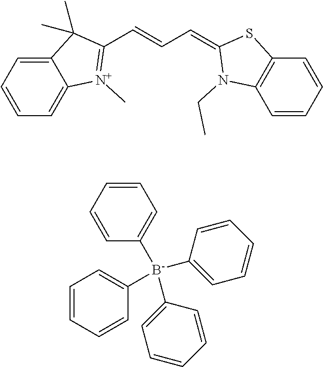 [SMILES: CCN1/C(=C\C=C\C2=[N+](C)c3ccccc3C2(C)C)Sc2ccccc21 ; c1ccc([B-](c2ccccc2)(c2ccccc2)c2ccccc2)cc1]

Preparation of Farther Components for the Photopolymer Composition:

Preparation of Polyol 1:

A 1 l flask was initially charged with 0.18 g of tin octoate, 374.8 g of ε-caprolactone and 374.8 g of a difunctional polytetrahydrofuran polyether polyol (equivalent weight 500 g/mol OH), which were heated to 120° C. and kept at this temperature until the solids content (proportion of nonvolatile constituents) was 99.5% by weight or higher. Subsequently, the mixture was cooled and the product was obtained as a waxy solid.

Preparation of Urethane Acrylate 1 (Writing Monomer): Phosphorothloyltros(Oxybenzene-4,1-Diylcarbamoyloxyethane-2,1-Diyl) Trisacrylate

A 500 ml round-bottom flask was initially charged with 0.1 g of 2,6-di-tert-butyl-4-methylphenol, 0.05 g of dibutyltin dilaurate and 213.07 g of a 27% solution of tris(p-isocyanatophenyl) thiophosphate in ethyl acetate (Desmodur® RFE, product from Bayer MaterialScience AG, Leverkusen, Germany), which were heated to 60° C. Subsequently, 42.37 g of 2-hydroxyethyl acrylate were added dropwise and the mixture was still kept at 60° C. until the isocyanate content had fallen below 0.1%. This was followed by cooling and complete removal of the ethyl acetate in vacuo. The product was obtained as a partly crystalline solid.

Preparation of Urethane Acrylate 2 (Writing Monomer): 2-({[3-(Methylsulphanyl)Phenyl]Carbamoyl}Oxy)Ethyl Prop-2-Enoate

A 100 ml round-bottom flask was initially charged with 0.02 g of 2,6-di-tert-butyl-4-methylphenol, 0.01 g of Desmorapid Z, 11.7 g of 3-(methylthio)phenyl isocyanate [28479-1-8], and the mixture was heated to 60° C. Subsequently, 8.2 g of 2-hydroxyethyl acrylate were added dropwise and the mixture was still kept at 60° C. until the isocyanate content had fallen below 0.1%. This was followed by cooling. The product was obtained as a colourless liquid.

Preparation of Additive 1 Bis(2,2,3,3,4,4,5,5,6,6,7,7-Dodecafluoroheptyl)(2,2,4-Trimethylhexane-1,6-Diyl) Biscarbamate

A 50 ml round-bottom flask was initially charged with 0.02 g of Desmorapid Z and 3.6 g of 2,4,4-trimethylhexane 1,6-diisocyanate (TMDI), and the mixture was heated to 60° C. Subsequently, 11.9 g of 2,2,3,3,4,4,5,5,6,6,7,7-dodecafluoroheptan-1-ol were added dropwise and the mixture was still kept at 60° C. until the isocyanate content had fallen below 0.1%. This was followed by cooling. The product was obtained as a colourless oil.

Preparation of the Borate (Photoinitiator): Benzylhexadecyklimethylammonium Tris-(3-Chloro-4-Methylphenyl)Hexylborate

Prepared according to WO 2015/055576 A1.

Triazine 1

2-(3-Methoxystyryl)-4,6-bis(trichloromethyl)-1,3,5-triazine

Prepared analogously to U.S. Pat. No. 3,987,037.

Triazine 2

2-(4-(2-Ethylhexyl)carbonylphenyl)-4,6-bis(trichloromethyl)-1,3,5-triazine

Prepared analogously to EP 0 332 042.

Production of Media to Determine the Holographic Properties

Production of Holographic Media on a Film Coating System

There follows a description of the continuous production of holographic media in the form of films of inventive and noninventive photopolymer compositions.

For the production, the film coating system shown in FIG. 1 was used, and the individual components are assigned the reference numerals which follow. FIG. 1 shows the schematic structure of the coating system used. In the figure, the individual components have the following reference numerals:
1, 1′ reservoir vessel
2, 2′ metering unit
3, 3′ vacuum devolatilization unit
4, 4′ filter
5 static mixer
6 coating unit
7 air circulation dryer
8 carrier substrate
9 covering layer

To produce the photopolymer composition, a mixture of 30.0 g of urethane acrylate 1 and 30.0 g of urethane acrylate 2, 22.5 g of additive 1, 0.15 g of triazine 1 or 2, 1.5 g of the borate, 0.075 g of Fomrez UL 28 and 1.35 g of the surface-active additive BYK® 310 and 50 g of ethyl acetate was added stepwise to 53.7 g of polyol 1 (OH number 59.7), and mixed. Subsequently, 0.3 g of a dye according to the invention was added to the mixture in the dark and mixed, so as to obtain a clear solution. If necessary, the composition was heated at 60° C. for a short period in order to bring the starting materials into solution more quickly. This mixture was introduced into one of the two reservoir vessels 1 of the coating rig. The second reservoir vessel 1′ was charged with the polyisocyanate component (Desmodur® N 3900, commercial product from Bayer MaterialScience AG, Leverkusen, Germany, hexane diisocyanate-based polyisocyanate, proportion of iminooxadiazinedione at least 30%, NCO content: 23.5%). The two components were then each conveyed by means of the metering units 2 in a ratio of 18.2 (component mixture) to 1.0 (isocyanate) to the vacuum devolatilization unit 3 and devolatilized. From here, they were then each passed through the filters 4 into the static mixer 5, in which the components were mixed to give the photopolymer composition. The liquid material obtained was then sent in the dark to the coating unit 6.

The coating unit 6 in the present case was a doctor blade system known to those skilled in the art. Alternatively, however, it is also possible to use a slot die. With the aid of the coating unit 6, the photopolymer composition was applied at a processing temperature of 20° C. to a carrier substrate 8 in the form of a 36 μm-thick polyethylene terephthalate film, and dried in an air circulation dryer 7 at a crosslinking temperature of 80° C. for 5.8 minutes. This gave a medium in the form of a film, which was then provided with a 40 μm-thick polyethylene film as covering layer 9 and wound up. All these steps were effected in the dark.

The desired layer thickness of the film was preferably 1 to 60 μm, preferably 5 to 25 μm, more preferably 10 to 15 μm.

The production speed was preferably in the range from 0.2 m/min to 300 m/min and more preferably in the range from 1.0 m/min to 50 m/min.

The layer thickness achieved in the film was 12 μm±1 μm.

Comparative Medium V

The above procedure was followed, except that 0.3 g of one of the comparative dyes was used.

Holographic Testing:

The media obtained as described were tested for their holographic properties by using a measuring arrangement as per FIG. 2 in the manner described above (see test methods, Determination of diffraction efficiency in pulsed exposure). The following measurements were obtained for DE at a fixed dose of 100 mJ/cm²:

TABLE 2
Holographic assessment of selected media and comparative media

| | | Dye | Triazine 1 | Triazine 2 | DE |
|---|---|---|---|---|---|
| Medium | Dye | [%] | [%] | [%] | [%] |
| B-1 | Example 5 | 0.2 | 0.1 | | 49 |
| B-2 | Example 11 | 0.2 | 0.1 | | 41 |
| B-3 | Example 14 | 0.2 | 0.1 | | 21 |
| B-4 | Example 3 | 0.2 | 0.1 | | 16 |
| B-5 | Example 5 | 0.2 | | 0.1 | 34 |

| Compara- | | Compara- | Triazine | Triazine | |
|---|---|---|---|---|---|
| tive | | tive dye | 1 | 2 | DE |
| medium | Comparative dye | [%] | [%] | [%] | [%] |
| C-1 | Comparative dye 1 | 0.2 | 0.1 | | 8 |
| C-2 | Comparative dye 2 | 0.2 | 0.1 | | 3 |
| C-3 | Comparative dye 2 | 0.2 | | 0.1 | 2 |
| C-4 | Comparative dye 3 | 0.2 | 0.1 | | 2 |
| C-5 | Comparative dye 4 | 0.2 | 0.1 | | 0 |

The values found for Example media B-1 to B-5 show that the inventive chain-substituted cyanine dyes of the formula (I) used in the photopolymer compositions are very useful in holographic media to be exposed with pulsed laser. Comparative media C-1 and C-5 using analogous cationic dyes lacking inventive chain substituents are unsuitable for use in holographic media to be exposed with pulsed laser.

1.-16. (canceled)

17. A photopolymer composition comprising a photopolymerizable component and a photoinitiator system, wherein the composition contains a chain-substituted cyanine dye of the formula (I) 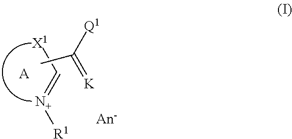
in which
K is a radical of the formula (II) 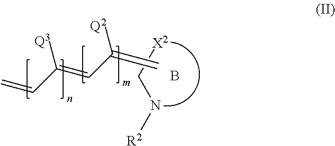
(III) 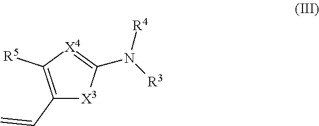
or (IV) 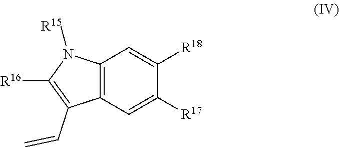
ring A together with N and X¹ and the atoms that connect them and ring B together with N and X² and the atoms that connect them are independently a five- or six-membered aromatic or quasiaromatic or partly hydrogenated heterocyclic ring which may contain 1 to 4 heteroatoms and/or may be benzo- or naphthofused and/or may be substituted by C₁- to C₈-alkyl, C₃- to C₆-alkenyl, C₄- to C₇-cycloalkyl or C₇- to C₁₀-aralkyl, aryl, fluorine, chlorine, bromine, methoxy, ethoxy, where the unsaturated unit (*(C=K)-Q¹) in the formula (I) joins onto the ring A or B in position 2 or 4 relative to X¹ or X²,
X¹ is O, S, N—R⁷, CR⁹ or CR¹¹R¹²,
X² is O, S, N—R⁸, CR¹⁰ or CR¹³R¹⁴,
Q¹ is hydrogen, cyano or methyl,
Q² is hydrogen or cyano,
Q³ is hydrogen or a radical of the formula (V) 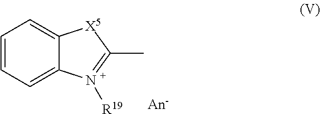
where at least one of the Q¹, Q² and Q³ radicals is not hydrogen,
X³ is O or S,
X⁴ is N or C—R⁶,
X⁵ is N, O or CR²⁰R²⁰,
R¹, R², R⁷, R⁸, R¹⁵ and R¹⁹ are independently C₁- to C₈-alkyl, C₃- to C₆-alkenyl, C₄- to C₇-cycloalkyl or C₇- to C₁₀-aralkyl and
R¹⁵ may additionally be hydrogen,
R⁹ and R⁰ are independently hydrogen or C₁- to C₂-alkyl,
R¹¹, R¹², R¹³, R¹⁴ and R²⁰ are independently C₁- to C₄-alkyl, C₃- to C₆-alkenyl, C₄- to C₇-cycloalkyl or C₇- to C₁₀-aralkyl or R¹¹ and R¹² together and/or R¹³ and R¹⁴ together form a —CH₂—CH₂—CH₂—CH₂— or —CH₂—CH₂—CH₂—CH₂—CH₂— bridge and, in addition,
R⁷, R⁹ or R¹² together with Q¹ can form a —CH₂—CH₂— or —CH₂—CH₂—CH₂— bridge,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³, R⁴ form a —CH₂—CH₂—CH₂—CH₂—, —CH₂—CH₂—CH₂—CH₂—CH₂—, —CH₂—CH—O—CH₂—CH₂—, —CH₂—CH₂—NH—CH₂—CH₂— or —CH₂—CH₂—N(alkyl)-CH₂—CH₂— bridge,
R⁵ and R¹⁶ are independently hydrogen, C₁- to C₈-alkyl, C₄- to C₇-cycloalkyl of C₆- to C₁₀-aryl,
R⁶ is hydrogen, alkyl or cyano,
R¹⁷ and R¹⁸ are independently hydrogen, chlorine, methyl, ethyl, methoxy or ethoxy,
n and m are independently 0 or 1,
where m is only 1 when n is also 1, and
An⁻ represents the equivalent of one anion.

18. The photopolymer composition according to claim 17, wherein
Q¹ is cyano or, together with R¹², forms a —CH₂—CH₂—CH₂— bridge,
Q² is hydrogen
Q³ is hydrogen,
the ring A together with R¹, N and X¹ and the atoms that connect them are a radical of the formulae 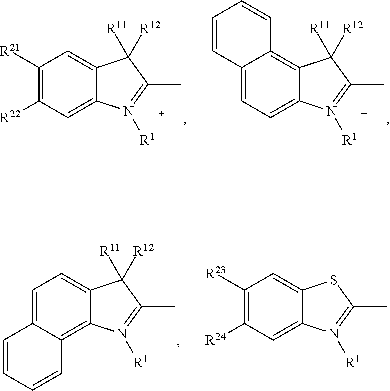
R¹ is C₁- to C₈-alkyl, C₃- to C₆-alkenyl, C₄- to C₇-cycloalkyl or C₇- to C₁₀-aralkyl,
R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy,
R²³ and R²⁴ are independently hydrogen, chlorine, cyano, methyl, ethyl, methoxy or ethoxy,
the ring B together with R², N and X² and the atoms that connect them are a radical of the formulae 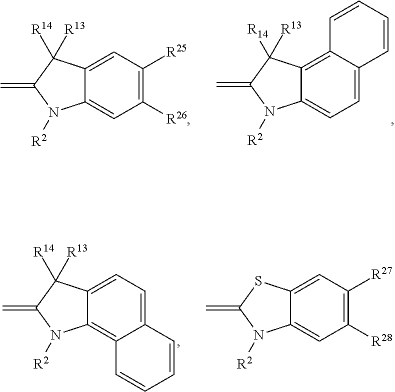
R² is C₁- to C₈-alkyl, C₃- to C₆-alkenyl, C₄- to C₇-cycloalkyl or C₇- to C₁₀-aralkyl,
R¹³ and R¹⁴ are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²⁵ and R²⁶ are independently hydrogen, chlorine, nitro, cyano, methoxycarbonyl, ethoxycarbonyl, methyl, ethyl, methoxy or ethoxy,
R²⁷ and R²⁸ are independently hydrogen, chlorine, cyano, methyl, ethyl, methoxy or ethoxy,
X³ is S,
X⁴ is N or C—R⁶,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³; R⁴ form a —CH₂—CH₂—CH₂—CH₂—, —CH₂—CH₂—CH₂—CH₂—CH₂— or —CH₂—(H₂—O—CH₂—CH₂— bridge,
R⁵ is C₁- to C₈-alkyl or C₆- to C₁₀-aryl,
R⁶ is hydrogen or cyano,
R¹⁵ is hydrogen, C₁- to C₈-alkyl, C₃- to C₆-alkenyl, C₄- to C₇-cycloalkyl or C₇- to C₁₀-aralkyl,
R¹⁶ is hydrogen, C₁- to C₄-alkyl, C₅- to C₆-cycloalkyl or C₆-aryl,
R¹⁷ and R¹⁸ are independently hydrogen, chlorine, methyl or methoxy,
n and m are independently 0 or 1,
where m is only 1 when n is also 1, and
An⁻ represents the equivalent of one anion.

19. The photopolymer composition according to claim 17, wherein
Q¹ is cyano or, together with R¹², forms a —CH₂—CH₂—CH₂— bridge,
Q² is hydrogen
Q³ is hydrogen,
the ring A together with R¹, N and X¹ and the atoms that connect them are a radical of the formulae 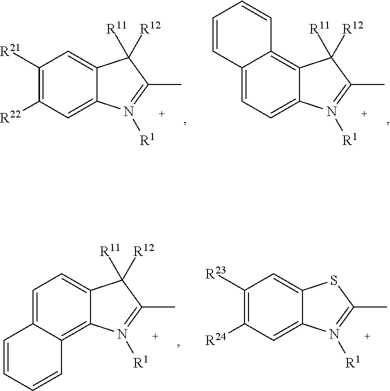
R¹ is C₁- to C₈-alkyl, C₃- to C₆-alkenyl, C₄- to C₇-cycloalkyl or C₇- to C₁₀-aralkyl,
R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy, where just one f the two is not hydrogen,
R²³ and R²⁴ are independently hydrogen, chlorine, cyano, methyl, ethyl, methoxy or ethoxy, where just one of the two is not hydrogen,
the ring B together with R², N and X² and the atoms that connect them are a radical of the formulae 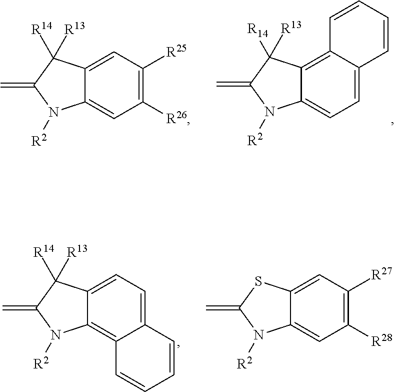
R² is C₁- to C₈-alkyl, C₃- to C₆-alkenyl, C₄- to C₇-cycloalkyl or C₇- to C₁₀-aralkyl,
R¹³ and R¹⁴ are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²⁵ and R²⁶ are independently hydrogen, chlorine, nitro, cyano, n ethoxycarbonyl, ethoxycarbonyl, methyl, ethyl, methoxy or ethoxy, where just one of the two is not hydrogen,
R²⁷ and R²⁸ are independently hydrogen, chlorine, cyano, methyl, ethyl, methoxy or ethoxy, where just one of the two is not hydrogen,
X³ is S,
X⁴ is N,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³; R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is C₁- to C₈-alkyl or C₆- to C₁₀-aryl,
R⁶ is hydrogen or cyano,
R¹⁵ is hydrogen, C₁- to C₈-alkyl, C₃- to C₆-alkenyl, C₄- to C₇-cycloalkyl or C₇- to C₁₀-aralkyl,
R¹⁶ is hydrogen, C₁- to C₄-alkyl, C₈- to C₆-cycloalkyl or C₆-aryl,
R¹⁷ and R¹⁸ are independently hydrogen, chlorine, methyl or methoxy, where just one of the two is not hydrogen,
n and m are independently 0 or 1,
where m is only 1 when n is also 1, and
An⁻ represents the equivalent of one anion.

20. The photopolymer composition according to claim 17, wherein
Q¹ and Q² are hydrogen,
Q³ is a radical of the formula (V),
the ring A together with R¹, N and X¹ and the atoms that connect them are a radical of the formulae 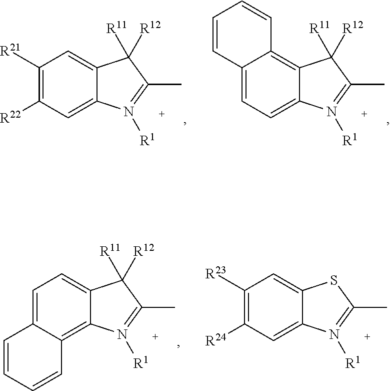
R¹ and R¹⁹ are independently C₁- to Ca-alkyl, C₃- to C₆-alkenyl, C₄- to CT-cycloalkyl or C₇- to C₁₀-aralkyl,
R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy,
R²³ and R²⁴ are independently hydrogen, chlorine, cyano, methyl, ethyl, methoxy or ethoxy,
the ring B together with R², N and X² and the atoms that connect them are a radical of the formulae 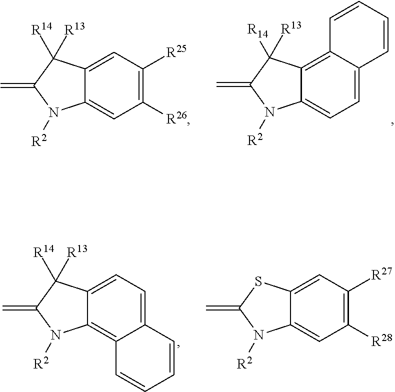
R² is C₁- to C₈-alkyl, C₃- to C₆-alkenyl, C₄- to C₇-cycloalkyl or C₇- to C₁₀-aralkyl,
R¹³ and R¹⁴ are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²⁵ and R²⁶ are independently hydrogen, chlorine, nitro, cyano, methoxycarbonyl, ethoxycarbonyl, methyl, ethyl, methoxy or ethoxy,
R²⁷ and R²⁸ are independently hydrogen, chlorine, cyano, methyl, ethyl, methoxy or ethoxy,
X⁵ is S or C(CH₃)₂,
X³ is S,
X⁴ is N or C—R⁶,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³, R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is C₁- to C₈-alkyl or C₆- to C₁₀-aryl,
R⁶ is hydrogen or cyano,
R¹⁵ is hydrogen, C₁- to C₈-alkyl, C₃- to C₆-alkenyl, C₄- to C₇-cycloalkyl or C₇- to C₁₀-aralkyl,
R¹⁶ is hydrogen, C1- to C4-alkyl, C5- to C6-cycloalkyl or C6-aryl,
R¹⁷ and R¹⁸ are independently hydrogen, chlorine, methyl or methoxy,
n and m are both 1 and
An⁻ represents the equivalent of one anion.

21. The photopolymer composition according to claim 17, wherein
Q¹ and Q² are hydrogen,
Q³ is a radical of the formula (V),
the ring A together with R¹, N and X¹ and the atoms that connect them are a radical of the formulae 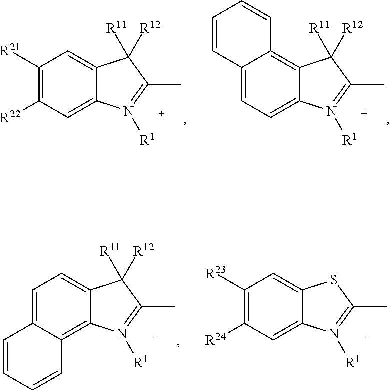
R¹ and R¹⁹ are independently C₁- to C₈-alkyl, C₃- to C₆-alkenyl, C₄- to C₇-cycloalkyl or C₇- to C₁₀-aralkyl,
R¹¹ and R¹² are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—C₂—CH₂—CH₂—CH₂— bridge,
R²¹ and R²² are independently hydrogen, chlorine, nitro, cyano, methoxycarbonyl, ethoxycarbonyl, methyl, ethyl, methoxy or ethoxy, where just one of the two is not hydrogen,
R²³ and R²⁴ are independently hydrogen, chlorine, cyano, methyl, ethyl, methoxy or ethoxy, where just one of the two is not hydrogen,
the ring B together with R², N and X² and the atoms that connect them are a radical of the formulae 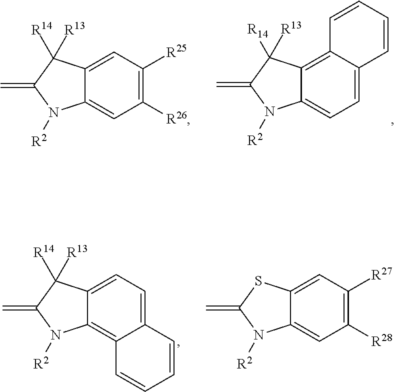
R² is C₁- to C₈-alkyl, C₃- to C₆-alkenyl, C₄- to C₇-cycloalkyl or C₇- to C₁₀-aralkyl,
R¹³ and R¹⁴ are independently C₁- to C₄-alkyl, C₃- to C₆-alkenyl, C₄- to C₇-cycloalkyl or C₇- to C₁₀-aralkyl, or together form a —CH₂—CH₂—CH₂—CH₂— or —CH₂—CH₂—CH₂—CH₂—CH₂— bridge,
R²⁵ and R²⁶ are independently hydrogen, chlorine, nitro, cyano, methoxycarbonyl, ethoxycarbonyl, methyl, ethyl, methoxy or ethoxy, where just one f the two is not hydrogen,
R²⁷ and R²⁸ are independently hydrogen, chlorine, cyano, methyl, ethyl, methoxy or ethoxy, where just one of the two is not hydrogen,
X⁵ is S or C(CH₃)₂,
X³ is S,
X⁴ is N,
R³ and R⁴ are independently C₁- to C₈-alkyl, C₃- to C₆-alkenyl, C₄- to CT-cycloalkyl, C₇- to C₁₀-aralkyl or C₆- to C₁₀-aryl or
R³, R⁴ form a —CH₂—CH₂—CH₂—CH₂—, —CH₂—CH₂—CH₂—CH₂—CH₂— or —CH₂—H₂—O—CH₂—CH₂— bridge,
R⁵ is C₁- to C₈-alkyl or C₆- to C₁₀-aryl,
R⁶ is hydrogen or cyano,
R¹⁵ is hydrogen, C₁- to C₈-alkyl, C₃- to C₆-alkenyl, C₄- to C₇-cycloalkyl or C₇- to C₁₀-aralkyl,
R¹⁶ is hydrogen, C1- to C4-alkyl, C5- to C6-cycloalkyl or C6-aryl,
R¹⁷ and R¹⁸ are independently hydrogen, chlorine, methyl or methoxy, where just one of the two is not hydrogen,
n and m are both 1 and
An⁻ represents the equivalent of one anion.

22. The photopolymer composition according to claim 17, wherein Q¹ is cyano or, together with R¹², forms a —CH₂—CH₂—CH₂— bridge,
Q² and Q³ are hydrogen,
the ring A together with R¹, N and X¹ and the atoms that connect them are a radical of the formulae 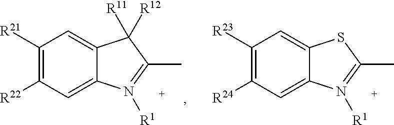
R¹ is methyl, ethyl, 1-propyl, 1-butyl, benzyl or cyanoethyl,
R¹¹ and R¹² are each independently methyl, ethyl or benzyl or together form a —CH₂—CH₂—CH₂—CH₂— or —CH₂—CH₂—CH₂—CH₂—CH₂— bridge,
R²¹ is hydrogen, chlorine, cyano, methoxycarbonyl, ethoxycarbonyl, methyl or methoxy,
R²³ and R²⁴ are hydrogen,
R²³ is hydrogen, chlorine, cyano, methyl or methoxy,
the ring B together with R², N and X² and the atoms that connect them are a radical of the formula 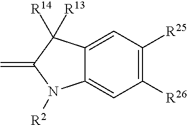
R² is methyl, ethyl, 1-propyl, 1-butyl, benzyl or cyanoethyl,
R¹³ and R¹⁴ are each independently methyl, ethyl or benzyl or together form a —CH₂—CH₂—CH₂—CH₂— or —CH₂—CH₂—CH₂—CH₂—CH₂— bridge,
R²⁵ is hydrogen, chlorine, cyano, methoxycarbonyl, ethoxycarbonyl, methyl or methoxy,
R²⁶ is hydrogen,
X³ is S,
X⁴ is N,
R³ and R⁴ are each independently methyl, ethyl, 1-propyl, 1-butyl, 1-octyl, cyclohexyl or benzyl or
R³, R⁴ form a —CH₂—CH₂—CH₂—CH₂—, —CH₂—CH₂—CH₂—CH₂—CH₂— or —CH₂—CH₂—O—CH₂—CH₂— bridge,
R⁵ is methyl, ethyl, tert-butyl, phenyl, 4-methylphenyl or 4-methoxyphenyl,
R¹⁵ is hydrogen, methyl, ethyl, 1-propyl, 1-butyl, 1-octyl or benzyl,
R¹⁶ is hydrogen, methyl or phenyl,
R¹⁷ is hydrogen, chlorine or methyl,
R¹⁸ is hydrogen and
An⁻ represents the equivalent of one anion.

23. The photopolymer composition according to claim 17, wherein the composition comprises matrix polymers and at least one writing monomer.

24. The photopolymer composition according to claim 17, wherein the photoinitiator system additionally comprises a coinitiator.

25. The photopolymer composition according to claim 24, wherein the coinitiator comprises at least one triazine.

26. The photopolymer comprising a photopolymer composition according to claim 23, wherein the matrix polymers are in a crosslinked state.

27. The photopolymer comprising a photopolymer composition according to claim 23, wherein the matrix polymers are in a three-dimensionally crosslinked state.

28. The photopolymer according to claim 23, wherein the matrix polymers are polyurethanes.

29. A holographic medium, especially in the form of a film, comprising a photopolymer according to claim 24.

30. A hologram comprising the holographic medium according to claim 29, wherein at holographic information has been exposed into same.

31. A process for recording of in-line, off-axis, full-aperture transfer, white light transmission, reflection, Denisyuk, off-axis reflection or edge-lit holograms and also of holographic stereograms, which comprises utilizing the hologram comprising the holographic medium according to claim 29.

32. A process for producing a holographic medium which comprises utilizing the photopolymer according to claim 24.

33. The process for according to claim 32, wherein the medium is exposed using pulsed laser radiation.

34. The process according to claim 33, wherein pulse durations of ≤200 ns are used.

35. A dye of the formula (I) 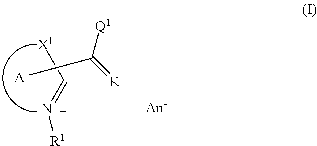
in which
K is a radical of the formula I 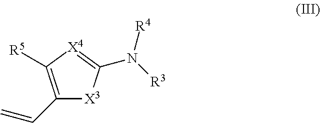
n and m are 0 and
ring A together with N and X¹ and the atoms that connect them are independently a five- or six-membered aromatic or quasiaromatic or partly hydrogenated heterocyclic ring which may contain 1 to 4 heteroatoms and/or may be benzo- or naphthofused and/or may be substituted by C₁- to C₈-alkyl, C₃- to C₆-alkenyl, C₄- to C₇-cycloalkyl or C₇- to C₁₀-aralkyl, aryl, fluorine, chlorine, bromine, methoxy, ethoxy, where the unsaturated unit (*(C=K)-Q¹) in the formula (I) joins onto the ring A or B in position 2 or 4 relative to X¹,
X¹ is O, S, N—R⁷, CR⁹ or CR¹¹R¹²,
Q¹ is hydrogen, cyano or methyl,
X³ is O or S,
X⁴ is N or C—R⁶,
R², and R⁷, and are independently C₁- to C₈-alkyl, C₃- to C₆-alkenyl, C₄- to C₇-cycloalkyl or C₇- to C₁₀-aralkyl and
R⁹ is independently hydrogen or C₁- to C₂-alkyl,
R¹¹ and R¹², are independently C₁- to C₄-alkyl, C₃- to C₆-alkenyl, C₄- to C₇-cycloalkyl or C₇- to C₁₀-aralkyl or R¹¹ and R¹² together form a —CH₂—CH₂—CH₂—CH₂— or —CH₂—CH₂—CH₂—CH₂—CH₂— bridge and, in addition,
R⁷, R⁹ or R¹² together with Q¹ can form a —CH₂—CH₂— or —CH₂—CH₂—CH₂— bridge,
R³ and R⁴ are independently C₁- to C₈-alkyl, C₃- to C₆-alkenyl, C₄- to C₇-cycloalkyl, C₇- to C₁₀-aralkyl or C₆- to C₁₀-aryl or
R³, R⁴ form a —CH₂—CH₂—CH₂—CH₂—, —CH₂—CH₂—CH₂—CH₂—CH₂—, —CH₂—CH₂—O—CH₂—CH₂—, —CH₂—CH₂—NH—CH₂—CH₂— or —CH₂—CH₂—N(alkyl)-CH₂—CH₂— bridge,
R⁵ are independently hydrogen, C₁- to C₈-alkyl, C₄- to C₇-cycloalkyl or C₆- to C₁₀-aryl,
R⁶ is hydrogen, alkyl or cyano, and
An⁻ represents the equivalent of one anion.
